(19) United States
(12) Patent Application Publication
(10) Pub. No.: US 2015/0105979 A1
(43) Pub. Date: Apr. 16, 2015

(54) DATA-LOGGING TRUCK CONTROL SYSTEM

(71) Applicant: LORD Corporation, Cary, NC (US)

(72) Inventors: Stephen F. Hilderband, Apex, NC (US); Jonathan M. Owens, Chapel Hill, NC (US); Florin Stefan Barbulescu, Fuquay-Varina, NC (US); Abraham Mathew, Cary, NC (US); Michael Mattson, Morrisville, NC (US)

(21) Appl. No.: 14/401,316

(22) PCT Filed: Jun. 25, 2013
(86) PCT No.: PCT/US2013/047628

§ 371 Date: Nov. 14, 2014

Related U.S. Application Data
(60) Provisional application No. 61/663,850, filed on Jun. 25, 2012.

(51) Int. Cl. B60G 17/015; B60G 17/0165; B60G 17/08; B60G 17/016

(52) U.S. Cl. CPC B60G 17/0155; B60G 17/0162; B60G 17/0164; B60G 17/0165; B60G 17/08
USPC 701/38

(57) ABSTRACT

A data-logging truck control system controls magnetorheological fluid dampers to protect a data-logging equipment payload of a data-logging truck from vibration and/or impulse shock forces.

### CROSS-REFERENCE TO RELATED APPLICATIONS

The present application claims priority to U.S. Provisional Patent Application No. 61/663,850 filed on Jun. 25, 2012 by Hildebrand, et al., entitled “Magneto-Rheological Damper System for Data-Logging Trucks” which is incorporated by reference herein as if reproduced in its entirety.

### BACKGROUND

Some off-road vehicles, such as oil field data-logging trucks, carry expensive payloads that are relatively sensitive to vibration and/or shock forces. In some cases, the vehicles comprise traditional vibration/shock isolators that do not provide sufficient damping and/or active damping of the vibration and/or shock forces to protect the payload while the vehicle traverses across the terrain, thereby resulting in damage to the payloads. Sometimes the payloads comprise expensive electronic equipment for data-logging well site information. In the oil field business, data-logging trucks are specialized trucks used to acquire data regarding a wellbore, a well, and a production field. By way of a non-limiting example, data-logging trucks comprise data recording data-logging trucks, seismic data-logging trucks and data-logging trucks used in hydraulic fracking. The data requirements are continually evolving and improving and the need to transport sensors and equipment (i.e. vibration and/or shock force sensitive payloads) to the well site. Sensitive electronic equipment carried by data-logging trucks often exceeds one million dollars in cost and it is not uncommon for the sensitive electronic equipment to be worth several millions of dollars.

Multiple configurations of data-logging trucks exist. Light and medium duty data-logging trucks are commonly four wheel (4×4) trucks. Heavy duty data-logging trucks are commonly dual rear axle trucks (6×6) and can weigh several tons when fully loaded. Data-logging trucks often carry a data acquisition box or housing mounted to the frame and are relatively top-heavy, which creates a high-center of gravity, thereby increasing the opportunity for rollover. Data-logging trucks are commonly exposed to harsh conditions that comprise rough dirt/rocky roads, no roads, well sites, open-hole environments, dust, heat, cold, and various extreme weather conditions. Although some attempts have been made to ruggedize the equipment by using various ruggedized racks holding sensitive data acquisition equipment and/or payloads, sensitive electronic equipment failure due to the positioning and traversal of the data-logging truck over the rough terrain causes high rates of failure of the sensitive electronic equipment. Depending upon the instrumentation package, the costs for replacing equipment carried by a data-logging truck may quickly grow into the millions of dollars. The extreme vibration and shock forces the data-logging truck payloads and/or sensitive electronic equipment experiences causes the owners of the data-logging trucks to replace the electronic equipment in intervals defined in terms of months instead of years. In some cases, the sensitive electronic equipment is so damaged while being carried by a data-logging truck that the sensitive electronic equipment actually breaks into pieces and is so unrecognizable it may be scooped of its enclosure with a shovel.

Many data-logging trucks carry a spool of wireline to lower into a wellbore. The wireline can weigh several tons. This heavy load of the wireline creates difficulty in driving the data-logging trucks on a highway, such as, for example, when the data-logging truck has large balloon tires that increase a spring force of the data-logging truck. The large balloon tires may also raise the high center of gravity of the data-logging truck so that a rollover potential is increased both on and off the road. To mitigate the rollover potential, operators drive the data-logging trucks substantially slower than posted speeds on the highway and significantly slow speeds off road, thereby lowering a utilization of the payload of the data-logging trucks. Further, the wireline systems comprise a plurality of sensors to convey data to the data-logging truck. The data-logging trucks often carry a plurality of sensitive electronic data acquisition and communications equipment that, as a result of being subjected to extreme shock and vibration, must be installed, calibrated, and/or repaired on-site after transporting the equipment. The major repairs to the payloads and/or sensitive electronic equipment and the resultant downtime of the data-logging truck yield non-productive time for the data-logging truck and therefore cost the company owning or leasing the data-logging truck lost revenue and/or force significantly high hourly rental rates for the data-logging truck.

### SUMMARY

In one aspect the invention provides for a data-logging truck. The data-logging truck comprising: a truck including a power plant and a cab; at least four wheels associated with the truck for propelling and guiding the truck, wherein the wheels are mechanically connected to the power plant; an electrical power source associated with the truck; a data acquisition housing secured to the truck; a magneto-rheological damper associated with each wheel, wherein the magneto-rheological damper has a first end and a second end, the first end connected to the wheel; at least two connection points associated with the cab and at least two connection points associated with the data acquisition housing, the connection points providing connectivity for the second end the associated magneto-rheological damper; at least one inertial sensor; and at least one controller having at least one control algorithm, the controller in electrical communication with the electrical power source, wherein the controller determines a distribution of electrical power to each magneto-rheological damper based upon an input from the inertial sensor and the algorithm.

In another aspect, a data-logging truck is provided. The data-logging truck comprising: a body; a power plant; a plurality of wheels, said wheels for engaging land and propelling said data-logging truck across land, said data-logging truck including a controllable suspension system, said controllable suspension system for controlling a plurality of suspension movements between said body and said wheels, a computer system; a plurality of suspension sensors located proximal to said wheels for measuring a plurality of suspension parameters representative of suspension movements between said body and said wheels, said sensor providing a plurality of suspension sensor measurement output signals; a plurality of controllable force suspension members located proximal said wheels and said suspension sensors, said controllable force suspension members for applying a plurality of controllable suspension travel forces between said body and said wheels to control said suspension movements; a body motion sensor, said body motion sensor for outputting a plurality of vehicle body motion measurement output signals; a vehicle databus interfacing with said computer system, said vehicle databus communicating a plurality of vehicle data communication signals; wherein said computer system receives said suspension sensor measurement output signals and said vehicle body motion measurement output signals and said computer readable medium including a first program instruction with said computer system executing a controllable suspension system algorithm for controlling said controllable force suspension members to control vehicle body motion and said suspension movements between said body and said wheels.

In yet another aspect, a method of minimizing an input force transmitted to a data-logging truck, said method comprising the steps: providing a data-logging truck, said data-logging truck having a body, a power plant, and a controllable suspension system, said controllable suspension system for controlling a plurality of suspension movements; providing a plurality of suspension sensors for measuring a plurality of suspension parameters representative of suspension movements of said body and outputting a plurality of suspension sensor measurement output signals; providing a plurality of controllable force suspension members, said controllable force suspension members for applying a plurality of controllable suspension travel forces; providing a body motion sensor, said body motion sensor for outputting a plurality of vehicle body motion measurement output signals; monitoring a plurality of sensor signals to identify an impending driver vehicle safety margin; and controlling said controllable force suspension members to minimize the input force transmitted to the data-logging truck.

### BRIEF DESCRIPTION OF THE DRAWINGS

For a more complete understanding of the present disclosure and the advantages thereof, reference is now made to the following brief description, taken in connection with the accompanying drawings and detailed description:

FIGS. 1A-E illustrate data-logging trucks with a data-logging truck control system.

FIGS. 2A-B illustrate a vehicle controllable suspension computer system.

FIG. 3 illustrates a semi-active controllable suspension system.

FIG. 4 illustrates a controllable force suspension member magneto-rheological fluid damper.

FIG. 5 illustrates data-logging trucks with data-logging truck control systems.

FIGS. 6A-B illustrate a data-logging truck with a data-logging truck control system computer system with a controllable suspension system for controlling controllable force suspension.

FIG. 7 illustrates a tracked data-logging truck with a data-logging truck control system, controllable suspension system, with a computer system, suspension sensors and controllable force suspension members at suspension locations for controlling suspension movements between the vehicle body and tracks.

FIG. 8 illustrates a data-logging truck with a data-logging truck control system, controllable suspension system, with a computer system, suspension sensors and controllable force suspension members at suspension locations for controlling suspension movements between the truck body and wheels.

FIG. 9 illustrates a data-logging truck with a data-logging truck control system, controllable suspension system, with a computer system, suspension sensors and controllable force suspension members at suspension locations for controlling suspension movements between the vehicle body and wheels.

FIG. 10 illustrates a data-logging truck with a data-logging truck control system, controllable suspension system, with a computer system, suspension sensors and controllable force suspension members at suspension locations for controlling suspension movements between the vehicle body and wheels.

FIGS. 11A-C illustrate controllable force suspension member magneto-rheological fluid dampers for controlling suspension movements.

FIGS. 12A-D illustrate controllable force suspension strut members with controllable adjustable air spring members and controllable force suspension member magneto-rheological fluid dampers, and a tractor data-logging truck controllable suspension system.

FIG. 13 illustrates a data-logging truck control system controllable suspension system single vehicle suspension corner with terrain mapping of the land engaged by the wheels of the data-logging truck.

FIG. 14 is a flowchart of a method of operating a data-logging truck control system.

FIG. 15 is a flowchart of another method of operating a data-logging truck control system.

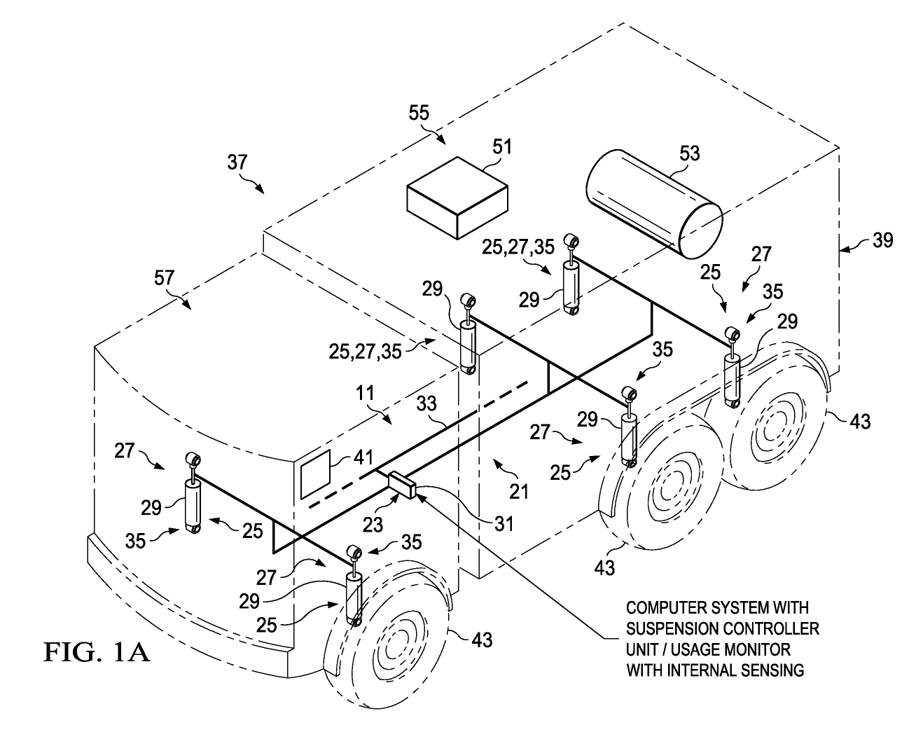

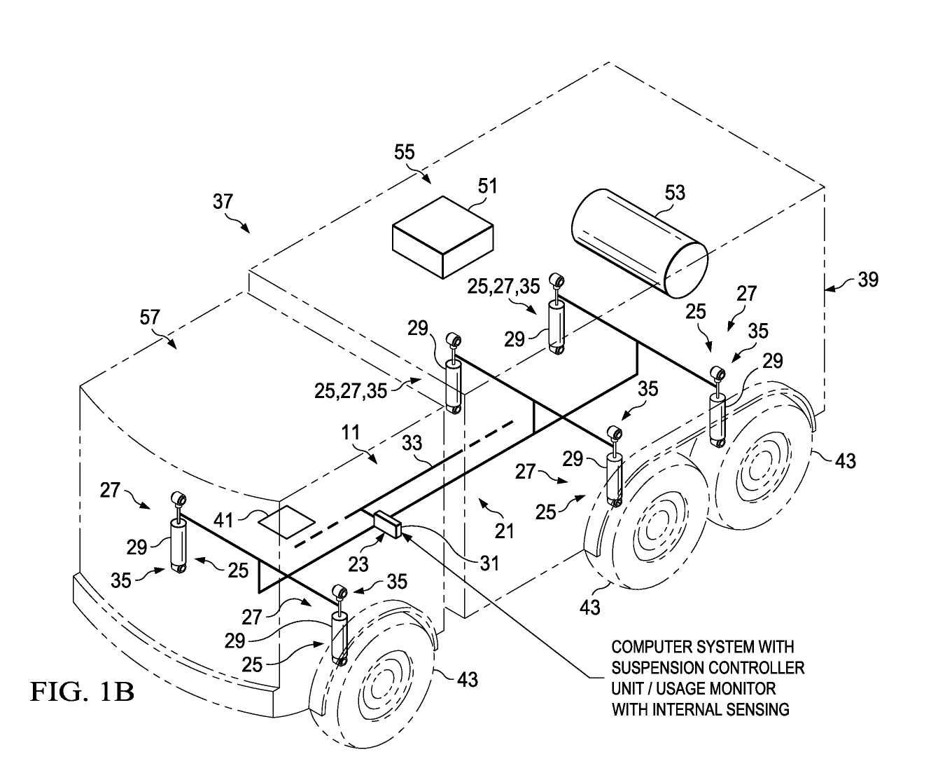

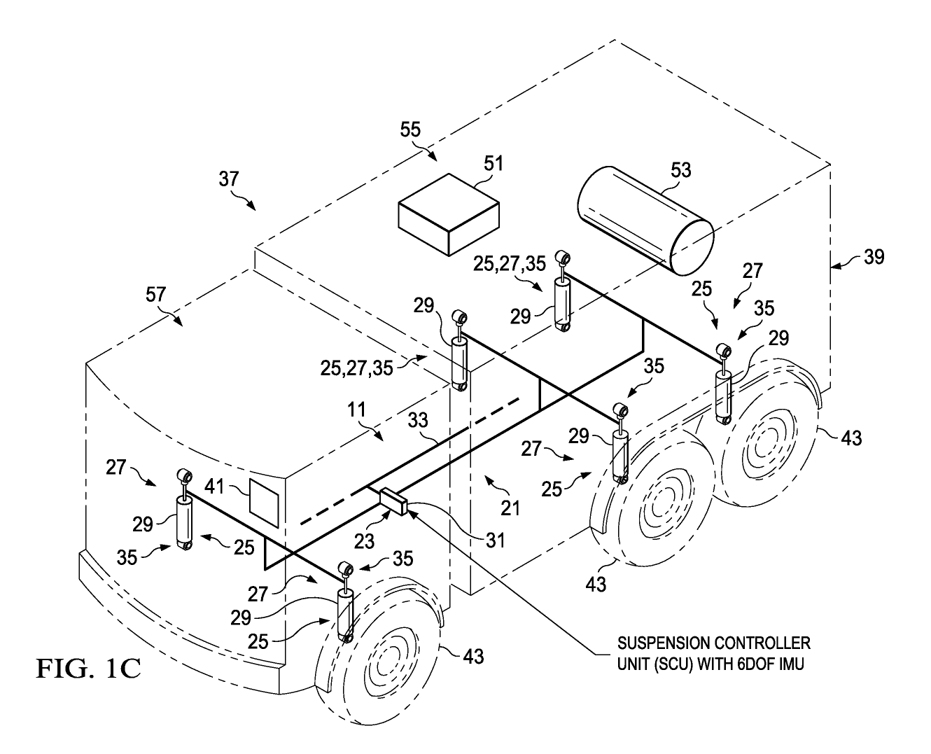

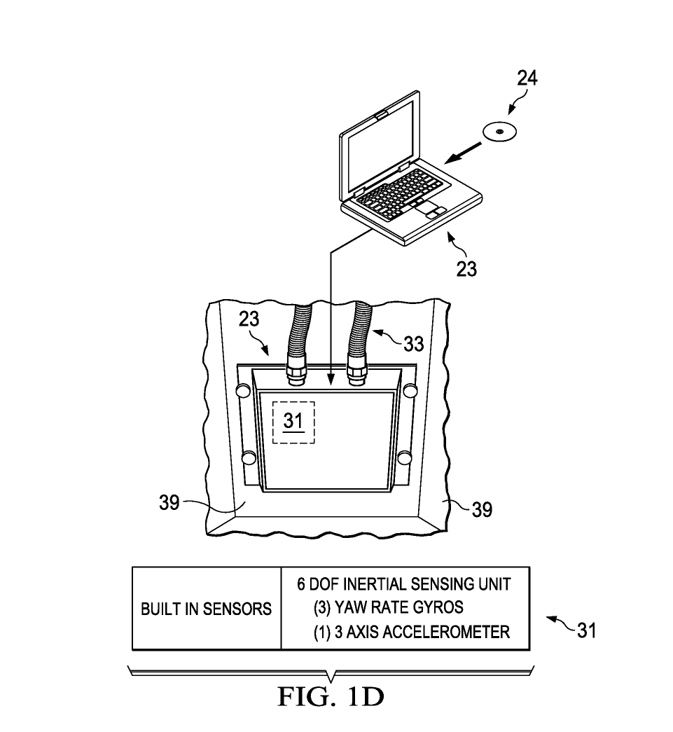

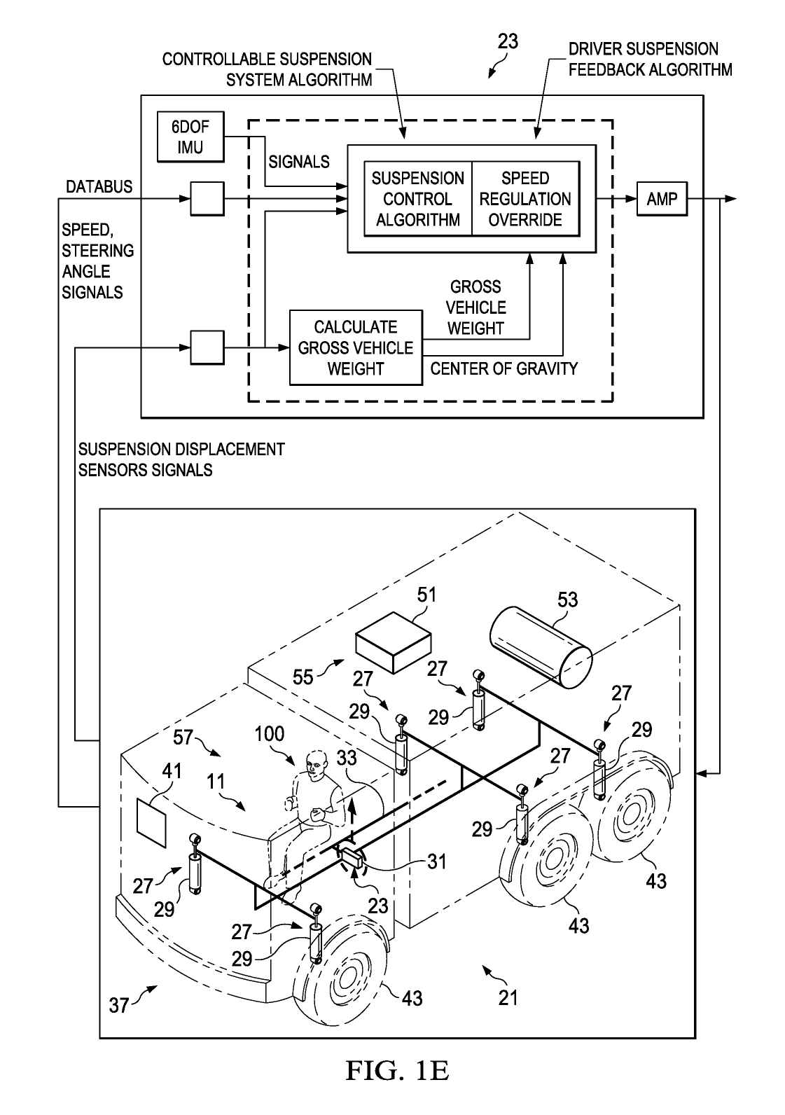

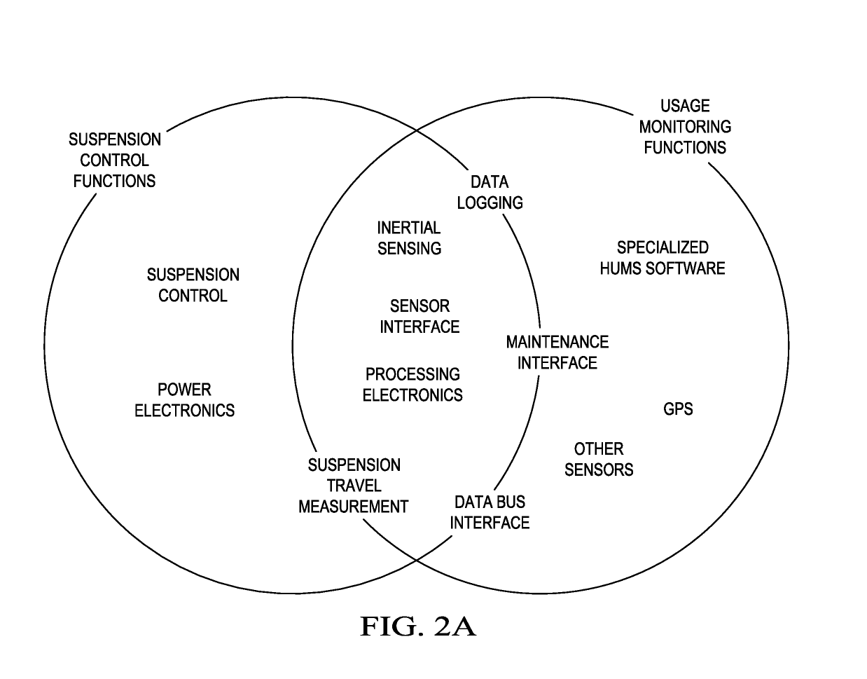

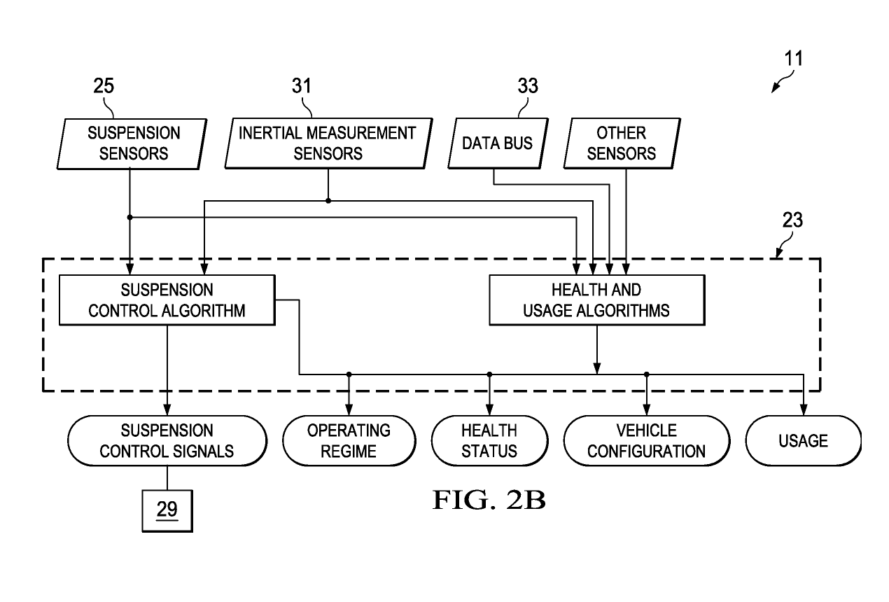

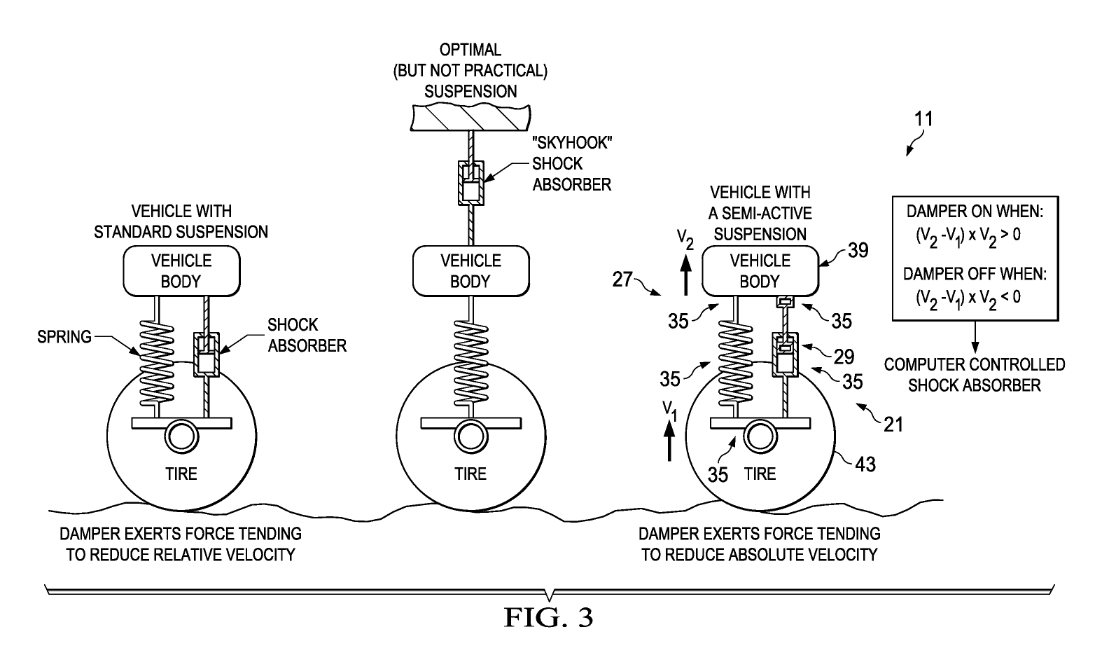

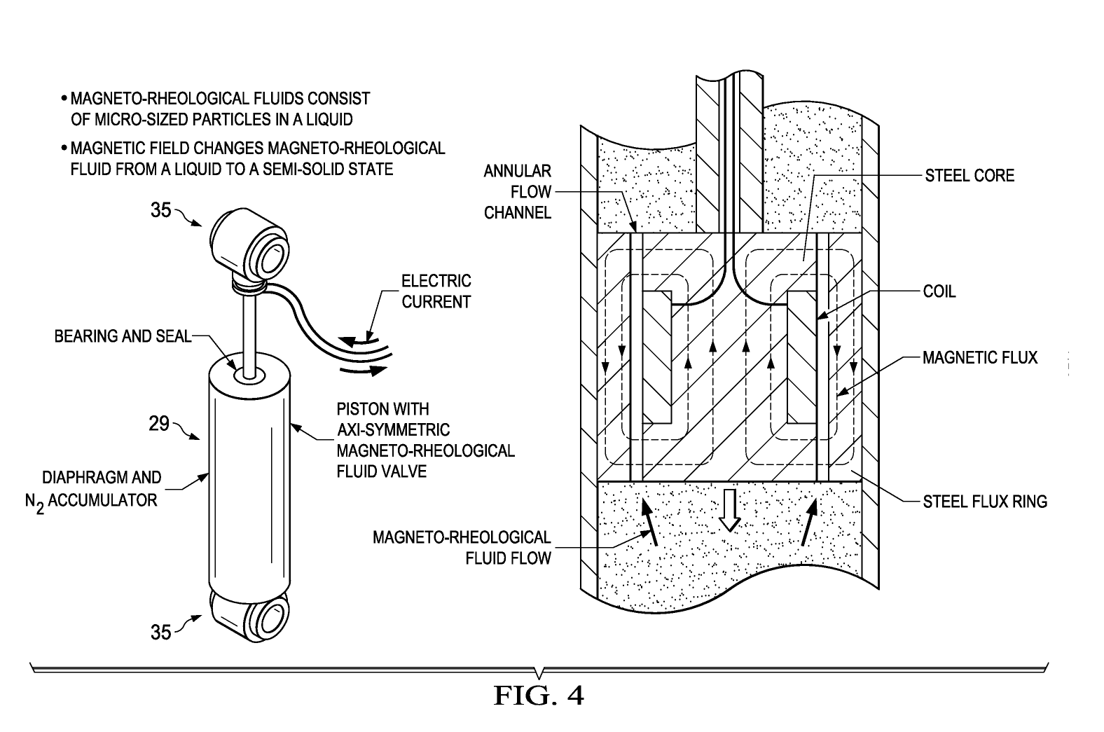

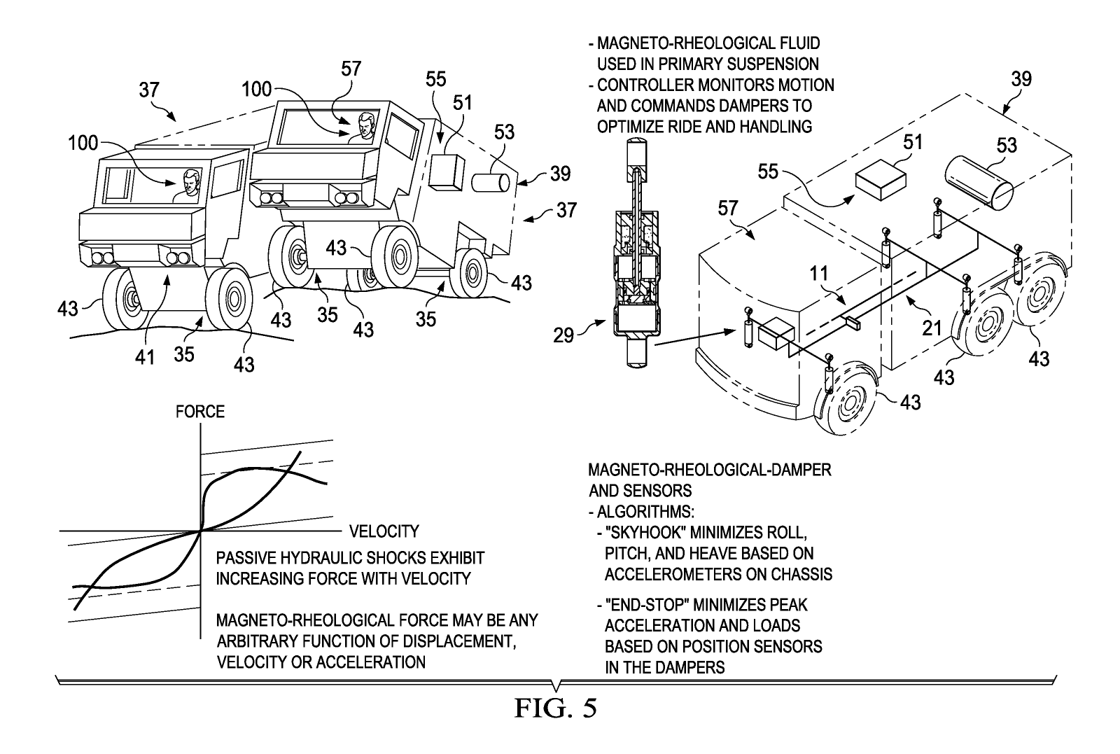

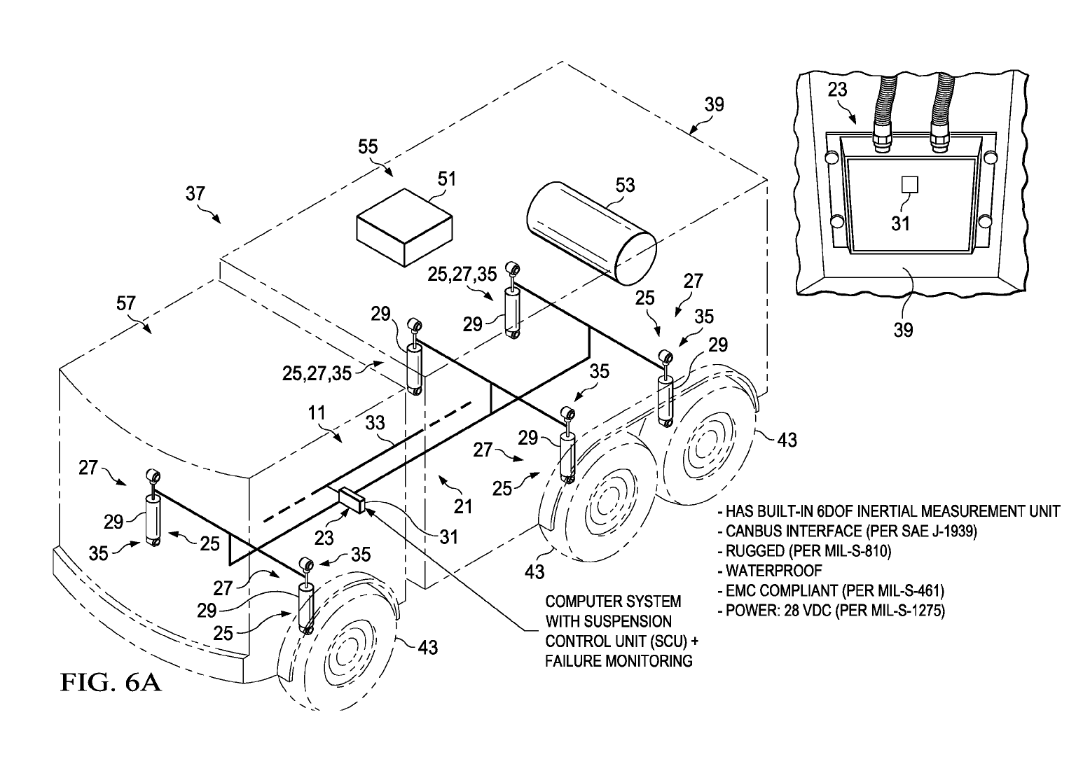

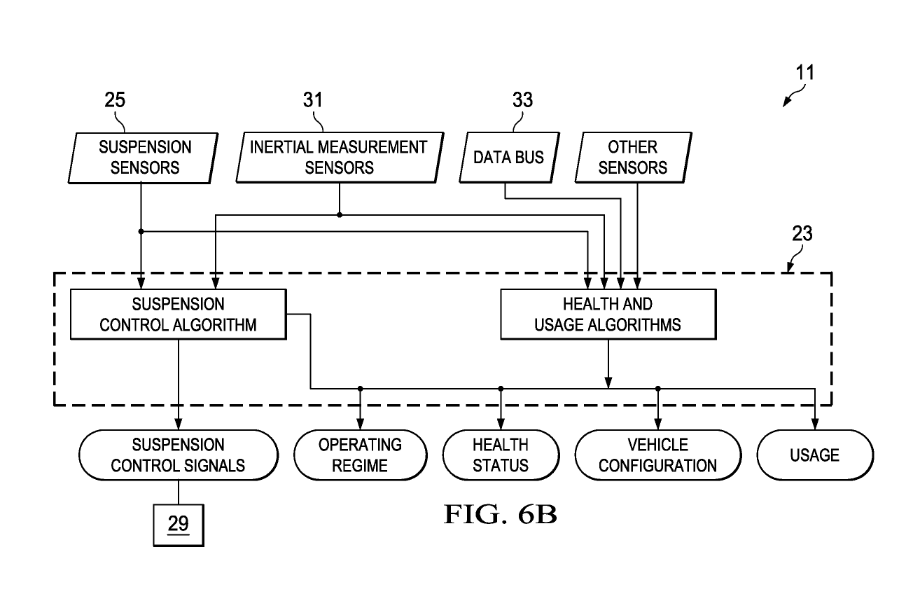

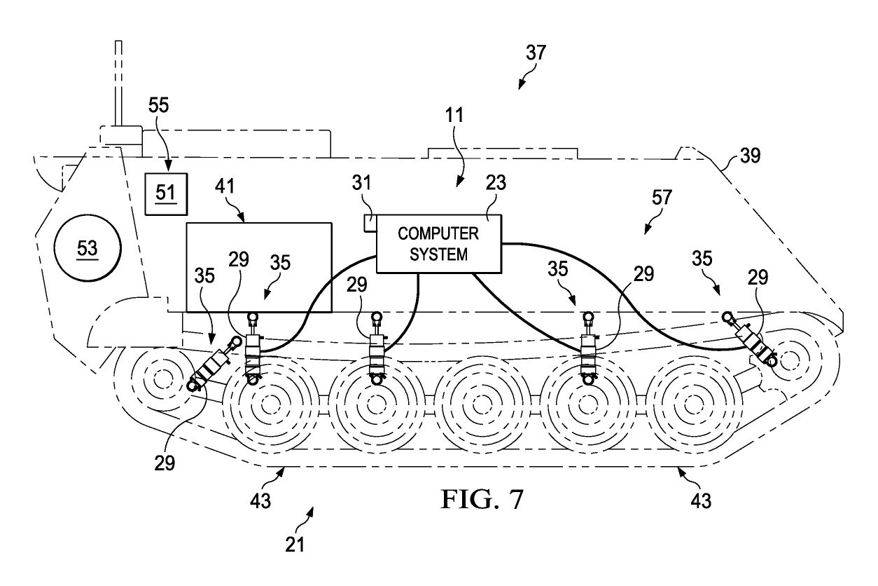

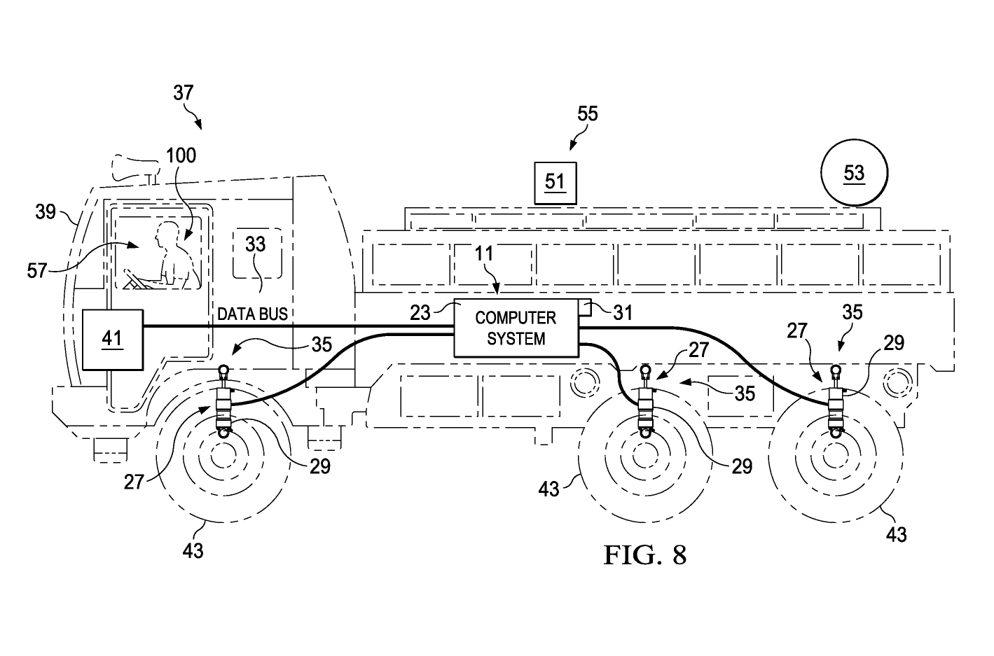

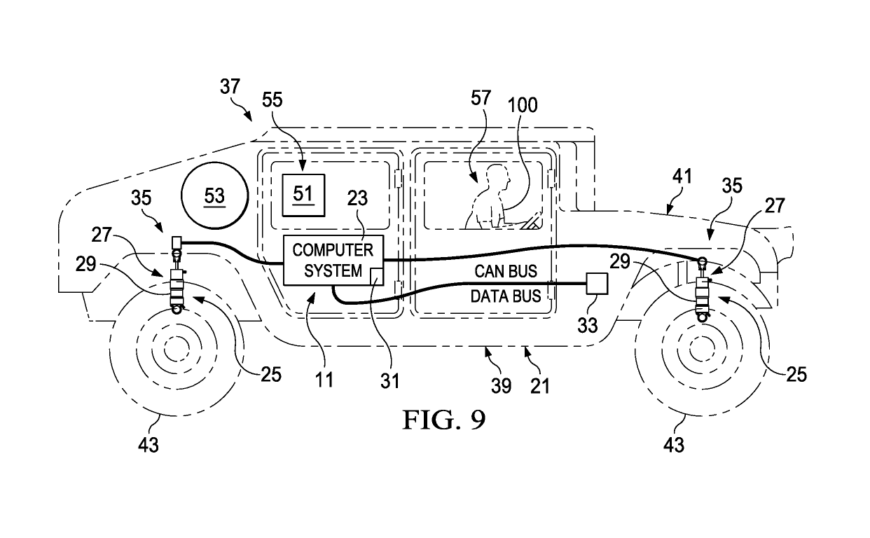

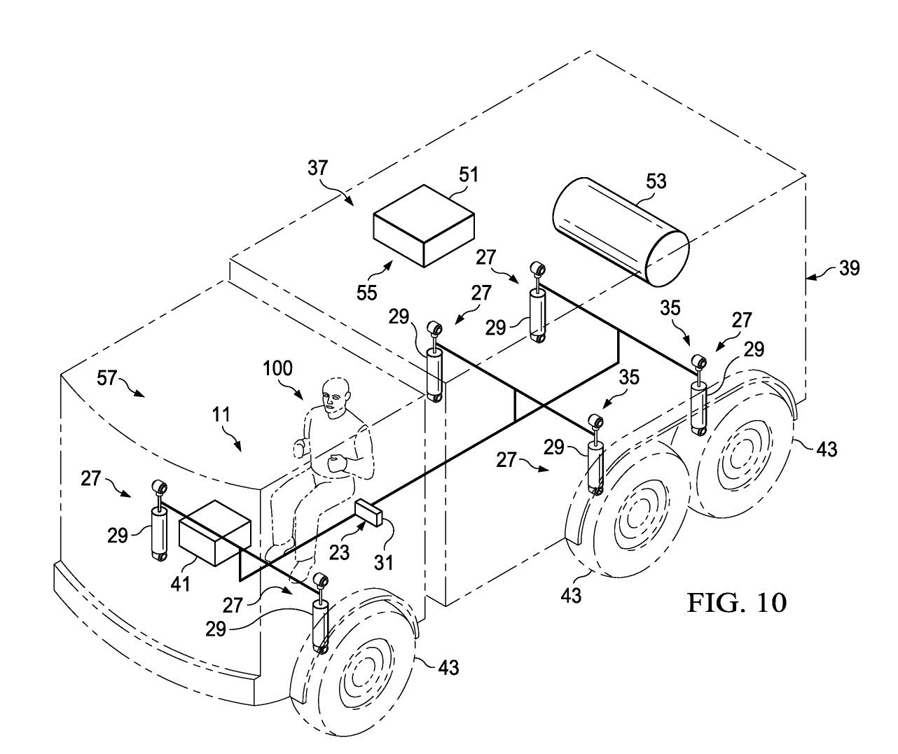

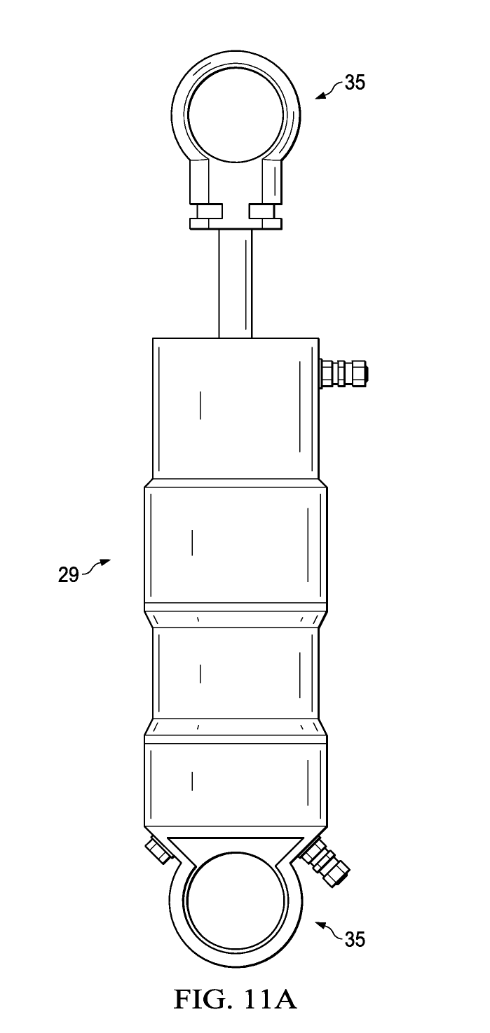

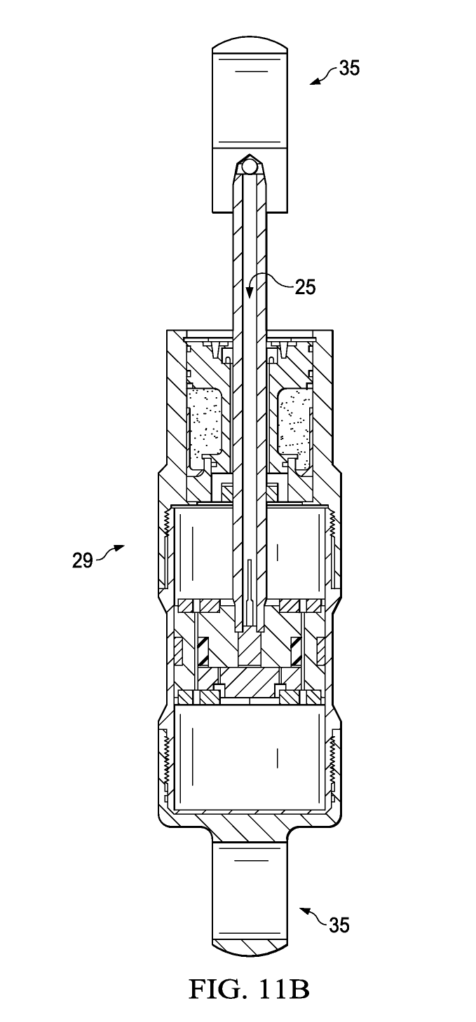

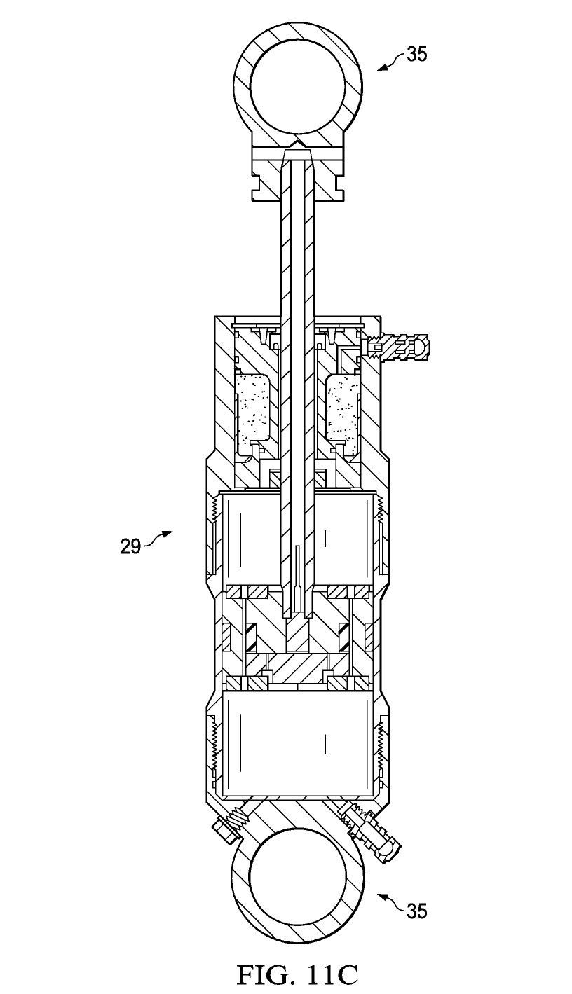

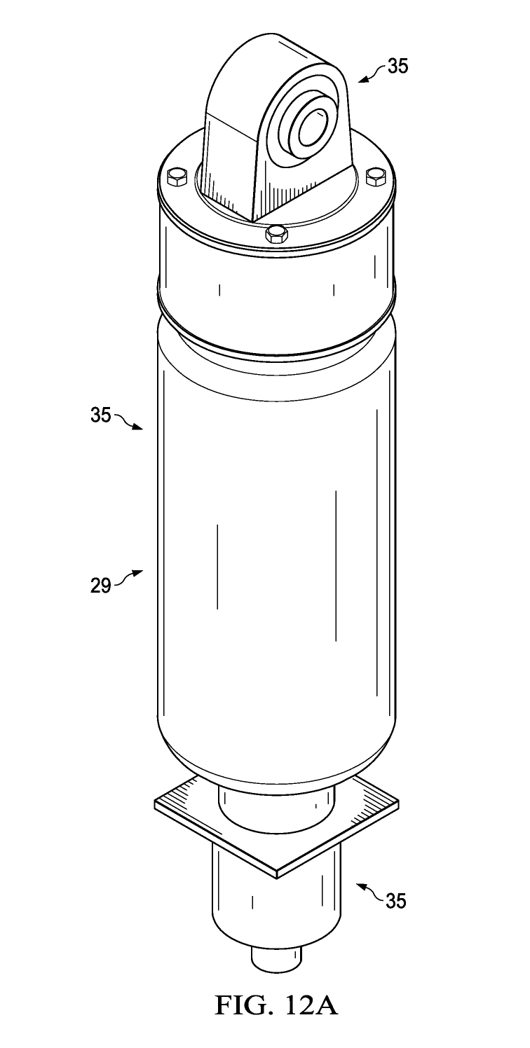

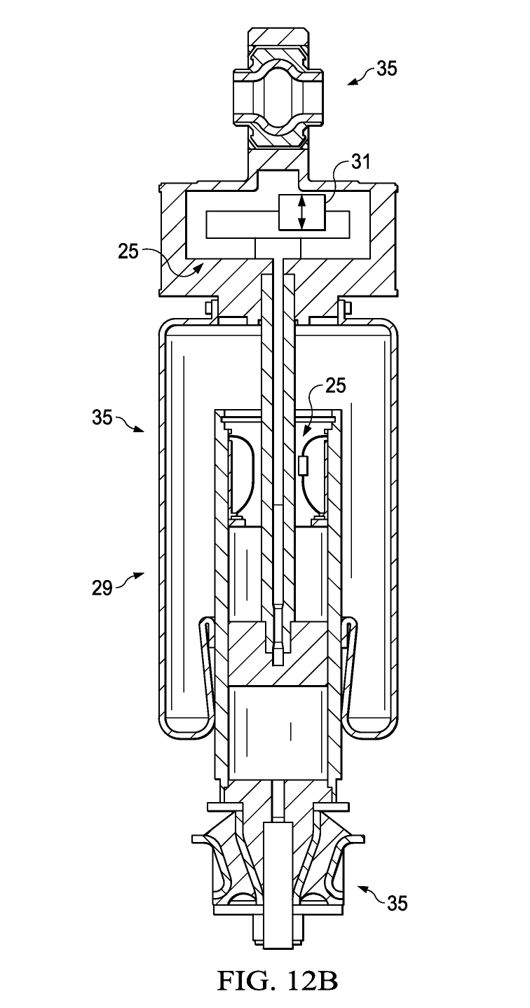

### DETAILED DESCRIPTION

In some embodiments the data-logging truck control system 11 comprises a suspension control system 21 including a computer system 23; a plurality of suspension sensors 25 located proximal to at least some of the suspension locations 27 for measuring suspension parameters; a plurality of controllable force suspension members 29 located proximal to at least some of the suspension locations 27 capable of applying forces across the suspension; a body motion sensor 31 for measuring vehicle body motion; a vehicle databus 33 interfacing with the computer system 23; wherein the computer system 23 receives the sensors' output signals and implements a suspension control algorithm for controlling the controllable force suspension members 29; and the computer system 23 monitors the health of the controllable suspension system with monitoring of the sensors and assessing the health of a plurality of vehicle suspension components 35; and the computer system 23 comprises regime recognition instructions for using the sensors and data on the databus 33 for determining a vehicle operating parameter and/or a vehicle operating configuration and/or vehicle safety margin to recognize a regime, and wherein the suspension control algorithm adjusts and controls the controllable force suspension members 29 to the recognized regime, in some embodiments with the controllable force suspension members 29 controlled to warn a driver 100 of a data-logging truck 37 of an impending driver safety margin wherein the driver is inhibited from crossing the safety margin.

In some embodiments, the data-logging truck control system 11 further comprises a data-logging equipment payload 51. The payload 51 may comprise electronics and/or mechanisms that are generally sensitive to vibration and/or impulse shock forces. The payload 51 may generally be located and/or inertially associated with a first inertial reference zone 55 so that the inertial force components associated with the first inertial reference zone 55 are significantly related to the inertial force components to which the payload 51 is associated. The data-logging truck control system 11 may further comprise a wireline 53. In some embodiments, a second inertial reference zone 57 may be associated with the driver 100 and/or operator of the data-logging truck control system 11. Each of the first inertial reference zone 55 and the second inertial reference zone 57 may comprise sensors configured to sense, report, record, and/or otherwise monitor inertial forces related to at least one of the payload 51, the first inertial reference zone 55, and the second inertial reference zone.

In some embodiments the data-logging truck control system 11 comprises a data-logging truck 37, the data-logging truck 37 comprising a body 39, a power plant 41 and a plurality of wheels 43, the wheels 43 for engaging land and propelling the data-logging truck 37 across land, the data-logging truck 37 including a controllable suspension system, the controllable suspension system for controlling a plurality of suspension movements between the body 39 and the wheels 43. In some embodiments the wheels 43 are in some embodiments wheels. However, in some embodiments the wheels 43 are replaced with tracks. In some embodiments the data-logging trucks 37 are utility vehicles, in some embodiments non-car vehicles, in some embodiments non-light duty utility vehicles with plurality of driven on/off-road wheels, in some embodiments with the data-logging trucks 37 transporting payloads 51 and cargo in which the mass of the data-logging truck and payload 51/cargo, and the gross vehicle weight and center of gravity have a considerable variation over time, in some embodiments from a first gross vehicle weight/center of gravity to a later distal usage time second gross vehicle weight/center of gravity. In some embodiments the vehicles are off road enabled with more than two driven wheels. In some embodiments the data-logging trucks 37 are non-light duty vehicles comprising gross vehicle weight between about 7,000 lbs and about 33,000 lbs. Some increments in the range include, but are not limited to data-logging trucks 37 having gross vehicle weights >7,700 lbs, >=8,500 lbs, >=10,000 lbs, >=14,000 lbs, >=20,000 lbs, >=24,000 lbs, >=29,000 lbs, >=29,000 lbs, >=32,000 lbs, >=33,000 lbs. In some embodiments the data-logging trucks 27 are off-road/on-road vehicles in some embodiments designed to drive both on and off road. In some embodiments the data-logging trucks 27 are data-logging trucks 27 with payloads 51/cargos and center of gravities that vary over time. In some embodiments the data-logging trucks 27 safety margins of driving vary with a variation of payloads 51/cargos and center of gravities. In some embodiments with the non-light duty data-logging trucks 27, light duty vehicles are for example class A thru F2 automobiles; class MPV-B thru MPV-E multi-purpose vehicles; class SUV-A thru SUV-E sport utility vehicles; class PUP-B thru PUP-D pickup trucks; class CDV, MIC, MVAN vans.

The data-logging truck 37 with wheels 43 and controllable suspension system for controlling suspension movements between the body 39 and the wheels 43 comprises a computer system 23 with computer readable medium; and a plurality of suspension sensors 25 located proximal to at least some of the wheels 43 suspension locations 27, for measuring a plurality of suspension parameters representative of suspension movements between the body 39 and the wheels 43 and outputting a plurality of suspension sensor measurement output signals; a plurality of controllable force suspension members 29 located proximal the wheels 43 and the suspension sensors 25, the controllable force suspension members 29 for applying a plurality of controllable suspension travel forces between the body 39 and the wheels 43 to control the suspension movements. In some embodiments, the controllable force suspension members 29 are dampers, in some embodiments controllable force dampers with suspension displacement sensors.

The controllable suspension system comprises a body motion sensor 31, the body motion sensor 31 for outputting a plurality of vehicle body motion measurement output signals. In some embodiments the body motion sensor 31 is an inertial sensor, and is in some embodiments integrated with in the computer system 23 with the suspension controller unit and the usage monitor.

The vehicle comprises a vehicle databus 33 interfacing with the computer system 23, the vehicle databus 33 communicating a plurality of vehicle data communication signals with the computer system 23.

In some embodiments the computer system 23 receives the suspension sensor measurement output signals and the vehicle body motion measurement output signals and the computer readable medium comprises first program instructions with the computer system 23 executing a controllable suspension system algorithm for controlling the controllable force suspension members 29 to control vehicle body motion and the suspension movements between the body 39 and the wheels 43, and the computer readable medium including second program instructions with the computer system 23 executing a health usage monitoring algorithm for monitoring the output signals and assessing a health and a usage of a vehicle suspension component.

In some embodiments the vehicle comprises the suspension usage safety margin monitoring functionality with the controllable semi-active suspension. In some embodiments with the system the usage safety margin monitoring function accesses suspension component data such as suspension displacements, damper dissipated power and temperatures. In some embodiments with the system different suspension control algorithms or gains are employed based on usage identified profiles or usage regimes to provide improved performance, safety and/or improved reliability. In some embodiments with the system the suspension control algorithm and the monitoring utilize the additional data signals from the vehicle data bus (in some embodiments engine rpm, steering angle, tire speeds, brake engagement) and associated regimes to improve performance, safety and failure detection. In some embodiments with the body motion inertial measurement system and the suspension displacement sensors the system provides a vibration and load dosimeter. In some embodiments with the body motion inertial measurement system and the suspension displacement sensors the system provides an indication of the health of suspension components 35. In some embodiments with the body motion inertial measurement system and the suspension displacement sensors the system provides an improved terrain mapping. In some embodiments with the body motion inertial measurement system and the suspension displacement sensors the system provides an estimation of gross vehicle weight and CG, center of gravity location, with such signals monitored for vehicle safety margins. In some embodiments with the monitoring system with the inertial measurement system and the suspension displacement sensors the vehicle system provides a vibration and load dosimeter. In particular, the displacement sensors across the suspension system in some embodiments sense and record loads to the vehicle chassis coming through the suspension, and in some embodiments to loads/power absorbed by the driver. This, in combination, with vibration sensing can be used to assess load and vibration history of the vehicle and provide a measured basis for prognostics based on, for example, fatigue accumulation. In some embodiments with the usage monitoring system with the inertial measurement system and the suspension displacement sensors provide an indication of the health of vehicle suspension components 35, such as vehicle suspension springs, bushings, tie-rods, and associated vehicle components which are associated and connected with the suspension. The vehicle monitoring system detects anomalies in these sensor signals when compared to baseline (healthy suspension) signals. This system also provides faulty component isolation to enable faster “pit-crew style” human maintenance with the human maintainers in some embodiments provided advanced communication of the needed repair and required suspension components 35 for the repair. Furthermore, the suspension control system 21 in some embodiments in addition to safety margin warnings, modifies the suspension control policy in the event of a suspension component failure or impending failure to provide an optimal limp-home mode, in some embodiments by controllably limiting the force through a controllable force suspension member that has a detected failure or impending failure mode.

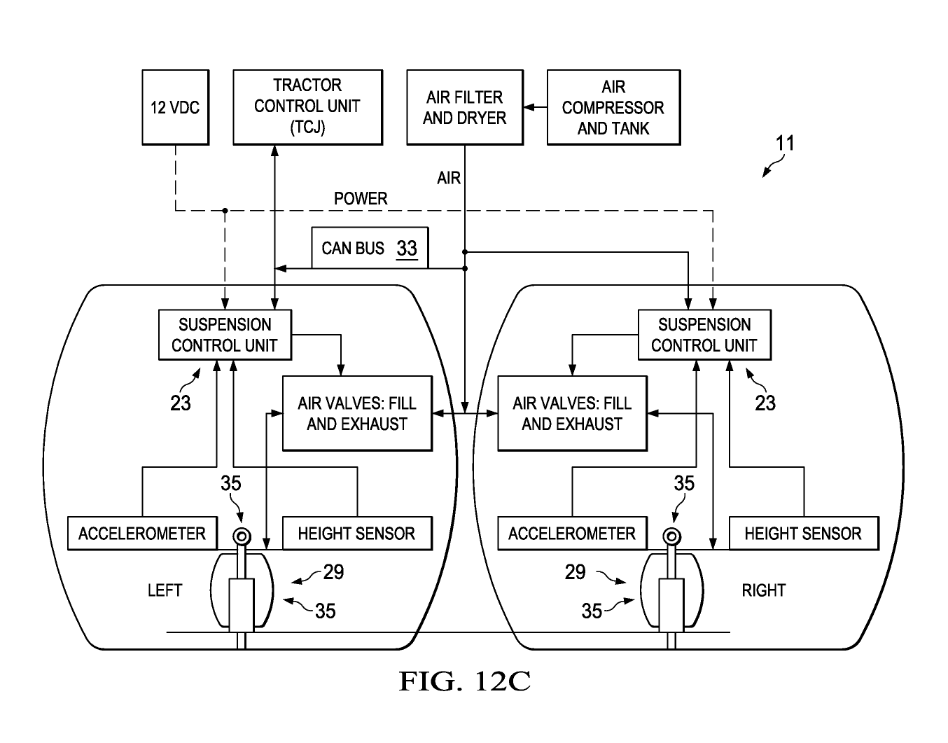

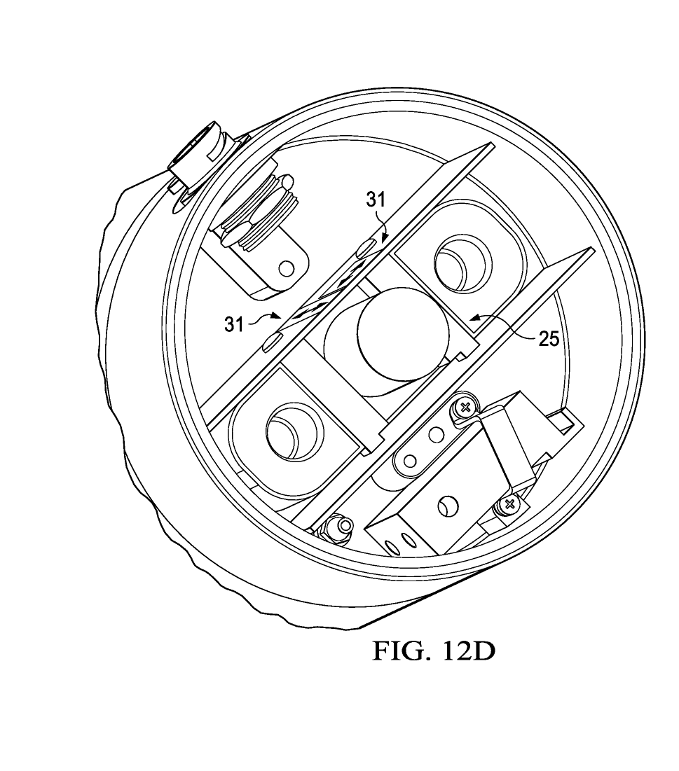

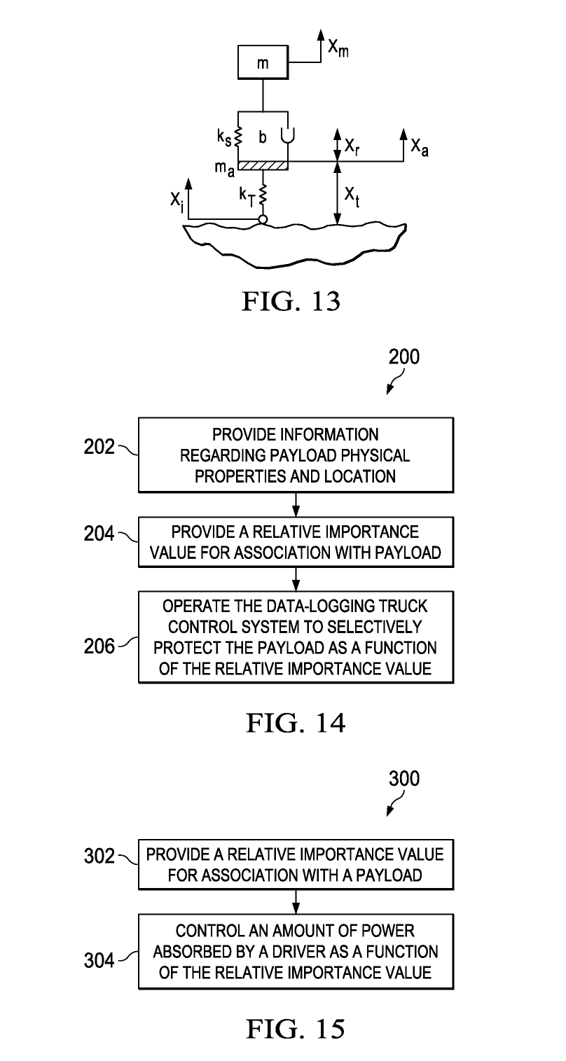

In an embodiment the vehicle system provides for geographic terrain mapping of the land engaged by the wheels 43. The body motion sensor 31 inertial measurement system and the suspension displacement sensors in some embodiments provide improved terrain mapping. Consider the single vehicle suspension corner illustrated in FIG. 13 where xᵢ is the terrain profile, xₜ is the time displacement, xᵣ is the suspension displacement which is measured and xₘ is the corner body displacement which can be estimated from the inertial measurement system in high-pass-filtered manner. The terrain profile is approximated by: xᵢ=xₘ−xᵣ−xₜ, where xₘ and xᵣ are known, but xₜ must be approximated by one of the following ways (a) assume kₜ>>kₛ such that xₜ<<xᵣ, then xₜ is assumed negligible or (b) assume tire damping and ma are small (i.e., kₜ/mₐ>>kₛ/m). Then, xₜ=(1/kₜ)*(kₛxᵣ+b(\dot{x}ᵣ)\dot{x}ᵣ)

If no land engaging tire lifting is assumed and masses and spring rates are known, then xₜ can be approximated by passing measure signals through second order filters based on system dynamic modeling.

Further accuracy in terrain mapping can be derived from averaging front and rear corner estimations on the vehicle. This may, for example, help remove data anomalies due to land engaging tire lift.

This terrain mapping technique provides the terrain characteristics that have relatively high spatial frequency (bumps, pot holes, ditches, etc.)—the cut-off of which is vehicle speed dependent. Low spatial frequency terrain characteristics, such as hills, can be estimated from an on-board geographic positioning input such as on-board GPS (Global Positioning Satellite) with known accuracy limits.

In some embodiments with the system the suspension displacement sensors output signals provide the system with inputs for a calculation of an estimation of gross vehicle weight and CG (center of gravity) location. This is in some embodiments done by simple statics equations based on suspension displacement measurements. Such information is in some embodiments used to calculate safety margins, monitor safety margins, detect exceedance, or determine excess capacity, or for usage monitoring, or for route planning, or to monitor fuel burn or payload depletion, in some embodiments to monitor the payload depletion of expendable payloads such as vehicle carried ammunition.

In some embodiments the system monitoring provides access to suspension component data signals from the sensors such as suspension displacements, damper dissipated power and damper temperatures. In some embodiments different suspension control algorithms or gains are employed based on identified usage profiles or usage regimes to provide improved safety, performance and/or improved reliability.

In some embodiments with the vehicle the computer system 23 computer readable medium comprises third program instructions with the computer system 23 executes a regime recognition algorithm for using the output signals and the vehicle data communication signals from the databus 33 to determine a vehicle operating parameter. In some embodiments with the vehicle the computer system 23 computer readable medium comprises third program instructions with the computer system 23 executes a regime recognition algorithm for using the output signals and the vehicle data communication signals from the databus 33 to determine a vehicle operating configuration. In some embodiments the regime recognition algorithm identifies the type of terrain that the vehicle is engaging, and in some embodiments modifies the controllable suspension system algorithm in accordance with the identified terrain type, in some embodiments with such identified terrain type utilized in the monitoring of impending safety margins.

In some embodiments the regime safety margin recognition algorithm identifies a vehicle operating configuration, such as a the vehicle weight cargo, fuel, personnel, and/or how the vehicle is functioning and driving and in some embodiments modifies the controllable suspension system algorithm in accordance with the vehicle operating configuration. In some embodiments with the vehicle the computer system 23 regime recognition algorithm identifies both regimes internal to the vehicle and regimes external to the vehicle, and modifies the controllable suspension system algorithm in accordance with such recognized regimes. The regime recognition comprises data signals from the suspension sensors 25 and body motion and the databus 33 with the regime recognizing the internal and external environmental conditions such as payload how the wheels 43 are engaging the land such as a muddy off road, the body motion such as on a steep slope, with the controllable suspension system algorithm modified in response to the regime recognition algorithm, in some embodiments with different algorithm gains depending upon the external environment regime, such as type of terrain and/or internal environment regime, such as location of vehicle CG and how the driver is driving through such external environment. The controllable suspension system algorithm is in some embodiments modified in response to the regime recognition algorithm. In some embodiments the regime recognition algorithm utilizes the sensor output signals and the vehicle data communication signals from the databus 33 to determine at least a vehicle operating parameter and a vehicle operating configuration and wherein the controllable suspension system algorithm is modified in response to the regime recognition algorithm. In some embodiments different controllable suspension system algorithm gains are utilized depending upon the type of terrain or location of vehicle CG, vehicle operating parameters, operator accelerating/braking, internal and external inputs and comparisons with stored data.

In some embodiments the at least first controllable force suspension member is comprised of a semi-active damper, in some embodiments with a control signal to the damper varies the damper force produced by damper. In some embodiments the semi-active damper is a magnetorheological fluid damper. In some embodiments the semi-active damper is controllable valve damper. In some embodiments the semi-active damper is a servo valve controlled damper. In some embodiments the semi-active damper is a controllable variable orifice damper. In some embodiments the semi-active damper is a controllable variable fluid flow damper.

In some embodiments the at least a first controllable force suspension member is comprised of an actuator, in some embodiments with a control signal to the actuator produces an active suspension contraction or extension.

In some embodiments the at least a first controllable force suspension member is comprised of a controllable spring. In some embodiments the controllable spring is comprised of an adjustable air spring member. In some embodiments the controllable spring is combined with a semi-active damper, in some embodiments a magnetorheological fluid damper. In some embodiments the controllable spring adjustable air spring member is controlled to adjust the vehicle height.

In some embodiments the suspension sensors 25 suspension sensor measurement output signals comprise a plurality of displacements between the body 39 and the wheels 43.

In some embodiments the body motion sensor 31 vehicle body motion measurement output signals comprise a plurality of rate sensor output signals, such as degree/sec, angular rate.

In some embodiments the body motion sensor 31 vehicle body motion measurement output signals comprise a plurality of accelerometer output signals, such as m/sec², linear acceleration. In some embodiments the body motion sensor 31 vehicle body motion measurement output signals comprise a plurality of six degrees of freedom of body motion output signals.

In some embodiments the computer system 23 stores a plurality of condition data for a plurality of vehicle suspension components 35 in the computer readable accessible data storage medium.

In some embodiments the computer system 23 provides a perceptible output when a vehicle suspension component is in need of corrective action such as in need of repair or replacement of a component because of a detected failure or a detected impending failure mode.

In some embodiments the controllable suspension system algorithm is modified in response to the monitored health usage of a sensed vehicle suspension component. The controllable suspension system algorithm is in some embodiments modified control the suspension force and/or ride height and to provide optimal limp-home mode, and to in some embodiments limit force through suspension controllable force members, such as a failing damper, in response to identified suspension component failure/impending failure modes.

In some embodiments the vehicle computer system 23 outputs a plurality of suspension output data to an external computer, the external computer external to the vehicle, in some embodiments a central depot computer, in some embodiments a logistics maintenance computer.

In some embodiments the suspension control algorithm adapts/adjusts gains and controls the suspension based on the type of terrain, such as paved road, unpaved dirt road, off-highway, no road at all, and uses current sensed terrain engaged land data and also compared with past terrain stored and/or shared data for the geographic location and how the driver is driving the vehicle. In some embodiments with adjustable height suspension, in some embodiments with controllable springs and adjustable height air springs, the height is lowered for on road travel, and the height is raised for off road travel, especially for terrain with large obstacles, such as rocks and logs. In some embodiments the monitoring system anticipates and identifies failures before and after failures, and then adjusts the suspension for limp home, in some embodiments limiting suspension force through damaged/failing/failed suspension components 35. In some embodiments with the wheels 43 primary controllable suspension system sensor output signals are outputted and the body sensor motion output signals are outputted to the computer system 23 which analyzes suspension system displacement at the wheels 43 to both monitor and collect data on the land/terrain that is being engaged and on the condition and health of the suspension system between the wheels 43 and the body 39 and the nearness of safety margins on how the driver is driving the vehicle. In some embodiments the system provides for monitoring of vehicle gross weight and CG, and additionally for backup monitoring of fuel usage, ammunition usage, and other consumable usage during a trip. In some embodiments the system reduces loading coming through the suspension system, in some embodiments with transmission of forces through the suspension members increased to warn of an impending safety margin hazard. In some embodiments the system provides for terrain mapping and regime recognition, and collects vehicle data signals, in some embodiments suspension sensor signals and body motion data signals combined with geographic location data signals, such as from GPS, to provide road/terrain condition map from wheels 43 engagement of the land collecting data on the land engaged. In some embodiments the system provides improved suspension control, safety and vehicle mobility with regime recognition.

In an embodiment the data-logging truck control system 11 comprises a data-logging truck 37 comprising a body 39, a power plant 41 and a plurality of wheels 43 the wheels 43 for engaging land and propelling the data-logging truck 37 across land. In some embodiments the system is for military data-logging trucks 37. In some embodiments the system is for utility vehicles, in some embodiments non-car vehicles, in some embodiments non-light duty utility vehicles with plurality of driven on/off-road engagers, and in some embodiments more than two driven wheels.

In some embodiments the data-logging truck system comprises a controllable suspension system. In some embodiments the controllable suspension system controls a plurality of suspension movements, between a first vehicle body and a second vehicle body, in some embodiments between the body 39 and the wheels 43, and a computer system 23 with computer readable medium. The computer system 23 in some embodiments comprises a central computer with a central processor, for controlling a plurality of controllable force suspension members 29. In alternative embodiments the computer system 23 comprises a distributed computer system 23 with subunits proximate suspension sites/controllable force suspension members 29 located proximal the wheels 43, with the distributed processing subunits linked together to communicate data. In some embodiments the data-logging truck 37 controllable suspension system comprises a plurality of suspension sensors 25 located proximal to, all or some of, the wheels 43 suspension locations 27 for measuring a plurality of suspension parameters representative of suspension movements between the body 39 and the wheels 43 and outputting a plurality of suspension sensor measurement output signals; a plurality of controllable force suspension members 29 located proximal the wheels 43 and the suspension sensors 25, the controllable force suspension members 29 for applying a plurality of controllable suspension travel forces between the body 39 and the wheels 43 to control the suspension movements; and body motion sensor 31, the body motion sensor 31 for outputting a plurality of vehicle body motion measurement output signals.

In some embodiments the data-logging truck controllable suspension system comprises a vehicle databus 33 interfacing with the computer system 23, the vehicle databus 33 communicating a plurality of vehicle data communication signals. In some embodiments the computer system 23 receives the suspension sensor measurement output signals and the vehicle body motion measurement output signals and executes a controllable suspension system algorithm for controlling the controllable force suspension members 29 to control vehicle body motion and the suspension movements between the body 39 and the wheels 43.

In some embodiments the computer system 23 executes a health usage monitoring algorithm for monitoring the output signals and assessing a health usage of a vehicle component, in some embodiments a plurality of vehicle components in the suspension and connected with the suspension. In some embodiments the system comprises a vehicle databus 33 interface interfacing with the computer system 23, the vehicle databus 33 interface communicating a plurality of vehicle data communication signals to the computer system 23.

In some embodiments the computer system 23 executes a regime recognition algorithm for using the output signals and inputted vehicle data communication signals from a vehicle databus 33 output to determine a vehicle operating parameter, such as a terrain type or a vehicle operating configuration such as the current loaded gross vehicle weight. In some embodiments the computer system 23 executes a regime recognition algorithm for using the output signals and the vehicle data communication signals from the databus 33 to determine a vehicle operating configuration and the controllable suspension system algorithm is modified in response to the regime recognition algorithm. In some embodiments the computer system 23 executes a regime recognition algorithm for using the output signals to determine at least a vehicle operating parameter and a vehicle operating configuration and wherein the controllable suspension system algorithm is modified in response to the regime recognition algorithm, such as different suspension algorithm gains are utilized depending upon type of terrain or location of vehicle CG, vehicle operating parameters, operator gas/braking, internal and external environmental inputs and comparisons with stored data.

In some embodiments the at least a first controllable force suspension member is comprised of a semi-active damper, with a control signal to the damper varying the damper force produced by damper, in some embodiments a MR damper.

In some embodiments the at least a first controllable force suspension member is comprised of an active suspension actuator.

In some embodiments the at least a first controllable force suspension member is comprised of a controllable spring, in some embodiments adjustable air spring member.

In some embodiments the suspension sensors 25 suspension sensor measurement output signals comprise a plurality of displacements between the body 39 and the wheels 43.

In some embodiments the body motion sensor 31 vehicle body motion measurement output signals comprise a plurality of rate sensor output signals (degree/sec, angular rate).

In some embodiments the body motion sensor 31 vehicle body motion measurement output signals comprise a plurality of accelerometer output signals (m/sec², linear acceleration). In some embodiments the body motion sensor 31 vehicle body motion measurement output signals comprise a plurality of six degrees of freedom of body motion output signals. In some embodiments the computer system 23 stores a plurality of condition data for a plurality of vehicle suspension components 35 in the medium. In some embodiments the computer system 23 provides a perceptible output when a vehicle suspension component is in need of corrective action. In some embodiments the controllable suspension system algorithm is modified in response to a health/usage of a sensed vehicle suspension component. In some embodiments the computer system 23 output signals a plurality of suspension output data to an external computer, in some embodiments a central depot computer, in some embodiments a logistics maintenance computer.

In an embodiment the data-logging truck control system 11 comprises a monitoring apparatus for diagnosing faults in the data-logging truck 37 comprising a body 39, a power plant 41 and a plurality of wheels 43, the wheels 43 for engaging land and propelling the data-logging truck 37 across land.

The apparatus including the controllable suspension system, the controllable suspension system for controlling a plurality of suspension movements between the body 39 and the wheels 43. The monitoring apparatus comprises the plurality of suspension sensors 25 located proximal to the wheels 43 suspension locations 27 for measuring a plurality of suspension parameters representative of suspension movements between the body 39 and the wheels 43 and outputting a plurality of suspension sensor measurement output signals. The monitoring apparatus comprises the plurality of controllable force suspension members 29 located proximal the wheels 43 and the suspension sensors 25, the controllable force suspension members 29 for applying a plurality of controllable suspension travel forces between the body 39 and the wheels 43 to control the suspension movements. The monitoring apparatus comprises the body motion sensor 31, the body motion sensor 31 for outputting a plurality of vehicle body motion measurement output signals. The monitoring apparatus receives the suspension sensor measurement output signals and the vehicle body motion measurement output signals and executes controllable suspension system instructions for controlling the controllable force suspension members 29 to control vehicle body motion and the suspension movements between the body 39 and the wheels 43, and the apparatus including computer system 23 reference data store containing failure mode identification data and associated system data sampled from behavior of the controllable suspension system in the failure mode; and a similarity engine responsive to monitored system data indicative of monitored behavior of the controllable suspension system, for generating at least one similarity value for a comparison of the monitored data to the failure mode associated system data, as a diagnostic indication of the failure mode. The monitoring apparatus in some embodiments comprises the computer system 23, with a central computer and/or distributed computer system 23 with subunits proximate suspension sites/controllable force suspension members 29 located proximal the wheels 43, linked together to communicate data. The monitoring apparatus in some embodiments comprises the vehicle databus 33 interfacing with the computer system 23, the vehicle databus 33 communicating a plurality of vehicle data communication signals. In some embodiments the system data is residual data. In some embodiments the monitoring apparatus further comprises a model for generating estimates of operational data in response to receiving operational data from the system; and a signal generator for differencing the estimates and the received operational data to generate the residual data. In some embodiments the model for generating estimates is a non-parametric model. In some embodiments the monitoring apparatus further comprises a failure identification module responsive to similarity values from the similarity engine for determining an indicated failure mode. In some embodiments the failure identification module compares similarity values for a plurality of failure modes in the data store, and identifies at least the failure mode with the highest similarity as an indicated failure mode of the system. In some embodiments the failure identification module compares similarity values for a plurality of failure modes in the data store, and identifies at least the failure mode with the highest average similarity as an indicated failure mode of the system. In some embodiments the failure identification module compares similarity values for a plurality of failure modes in the data store, and identifies as an indicated failure mode of the system at least the failure mode with at least a selected number of highest similarities over a window of successive comparisons.

In an embodiment the data-logging truck control system 11 comprises a method for diagnosing faults in a data-logging truck 37 comprising a body 39, a power plant 41 and a plurality of wheels 43, the wheels 43 for engaging land and propelling the data-logging truck 37 across land, the method including: providing a controllable suspension system, the controllable suspension system disposed between the body 39 and the wheels 43 to control a plurality of suspension movements between the body 39 and the wheels 43, the controllable suspension system including a plurality of suspension sensors 25 located proximal to all or some of the wheels 43 suspension locations 27 for measuring a plurality of suspension parameters representative of suspension movements between the body 39 and the wheels 43 and outputting a plurality of suspension sensor measurement output signals; a plurality of controllable force suspension members 29 located proximal the wheels 43 and the suspension sensors 25, the controllable force suspension members 29 for applying a plurality of controllable suspension travel forces between the body 39 and the wheels 43 to control the suspension movements; a body motion sensor 31, the body motion sensor 31 for outputting a plurality of vehicle body motion measurement output signals; with the controllable suspension system receiving the suspension sensor measurement output signals and the vehicle body motion measurement output signals and executing controllable suspension system instructions for controlling the controllable force suspension members 29 to control vehicle body motion and the suspension movements between the body 39 and the wheels 43, and the controllable suspension system acquiring monitored controllable suspension system data indicative of monitored controllable suspension behavior of the controllable suspension system; sampling controllable suspension system data from a controllable suspension failure mode to define controllable suspension reference system data associated with the controllable suspension failure mode, and comparing for similarity the monitored system data to the reference system data to generate a similarity value as a diagnostic indication of the controllable suspension failure mode. In some embodiments the controllable suspension system data is residual controllable suspension data. In some embodiments the method further comprises generating estimates of operational data in response to acquiring operational controllable suspension data from the controllable suspension system; and differencing the estimates and the received operational data to generate the residual controllable suspension data. In some embodiments the method further comprises the step of determining an indicated controllable suspension failure mode based on similarity values resulting from the similarity comparisons. In some embodiments the determining step comprises comparing the similarity values for a plurality of controllable suspension failure modes, and identifying at least the controllable suspension failure mode with the highest similarity as an indicated controllable suspension failure mode of the system. In some embodiments the determining step comprises comparing the similarity values for a plurality of failure modes, and identifying at least the failure mode with the highest average similarity as an indicated failure mode of the system.

In an embodiment, the data-logging truck control system 11 provides diagnostic capabilities in a monitoring system for data-logging trucks 27 and controllable suspension system. In some embodiments a collection of diagnostic conditions is provided as part of the operation of the computer controlled controllable suspension system on-line monitoring of the vehicle suspension system and vehicle components from physical components and subsystems instrumented with sensors. Output signals created by the on-line monitoring are in some embodiments compared to the diagnostic conditions collection, and if a signature of one or more diagnostic conditions is recognized in such output signals, the system provides a diagnosis of a possible impending suspension system failure mode. In some embodiments the diagnostics utilize a nonparametric empirical model that generates estimates of sensor values in response to receiving actual sensor values from the controllable suspension system sensors. The estimated sensor values generated by the model are in some embodiments subtracted from the actual sensor values to provide residual signals for the sensors. During normal vehicle use with the controllable suspension and related components functioning properly as modeled by the empirical model the residual signals are essentially zero with some noise from the underlying physical parameters and the sensor noise. Such residuals become move from zero when the controllable suspension and related vehicle components begin to fail. In some embodiments a sensitive statistical test such as the sequential probability ratio test is applied to the residuals to provide the earliest possible decision whether the residuals are moving off zero, often at such an early stage that the residual trend away from zero is still buried in the noise level. In some embodiments when a decision is made that the residual is non-zero, an alert is generated for that sensor for the relevant time period. Alternatively an alert may be generated to enforce thresholds on the residual itself for each parameter, alerting on that parameter when the thresholds are exceeded. The collected recorded diagnostic conditions can be referenced using the residual data itself, or alternatively using the sequential probability ratio test alert information or the residual threshold alert information. Failure modes are in some embodiments stored in the computer system 23 computer readable medium recordable diagnostic conditions collection. When the pattern of sequential probability ratio test alerts or residual threshold alerts matches the stored signature the failure mode is recognized, and the diagnosis made. Alternatively, when the residual data pattern is similar to a residual data pattern in the stored collection using a similarity engine, the corresponding failure mode is recognized and the diagnosis made. In some embodiments when the failure mode is recognized the controllable suspension system adjusts the control of the suspension system in response to such diagnosis, in some embodiments when force through a diagnosed component is to be limited until appropriate repair is made to correct such failure mode, in addition to providing explanatory descriptions, suggested investigative steps, and suggested repair steps either to a vehicle operator or communicated to an external depot maintenance computer.

In an embodiment, the data-logging truck control system 11 comprises a monitoring apparatus for diagnosing faults in a data-logging truck 37 comprising a body 39, a power plant 41 and a plurality of wheels 43, the wheels 43 for engaging land and propelling the data-logging truck 37 across land. The apparatus including a controllable suspension system, the controllable suspension system for controlling a plurality of suspension movements between the body 39 and the wheels 43, a plurality of suspension sensors 25 located proximal to all or some of the wheels 43 suspension locations 27 for sensing a plurality of suspension measurables and outputting a plurality of suspension sensor measurement output signals; a plurality of controllable force suspension members 29 located proximal the wheels 43 and the suspension sensors 25, the controllable force suspension members 29 for applying a plurality of controllable suspension travel forces between the body 39 and the wheels 43 to control the suspension movements; a body motion sensor 31, the body motion sensor 31 for outputting a plurality of vehicle body motion measurement output signals; the apparatus receives the suspension sensor measurement output signals and the vehicle body motion measurement output signals and executes controllable suspension system instructions for controlling the controllable force suspension members 29 to control vehicle body motion and the suspension movements between the body 39 and the wheels 43, and the apparatus including computer readable failure mode reference identification data for detecting a failure mode in the controllable suspension system; and the apparatus compares monitored controllable suspension system data to the failure mode reference identification data to a diagnose an impending failure mode of the controllable suspension system. The apparatus including the computer system 23 with the central computer and/or the distributed computer system 23 with subunits proximate suspension sites/controllable force suspension members 29 located proximal the wheels 43, and linked together to communicate data. The apparatus in some embodiments comprises the vehicle databus 33 interfacing with the computer system 23, the vehicle databus 33 communicating a plurality of vehicle data communication signals. In some embodiments the apparatus comprises a global geographic positioning input, wherein the apparatus collects the suspension sensor measurement output signals and the vehicle body motion measurement output signals with the geographic positioning inputs to provide a computer readable media stored geographic data map indicating land terrain suspension land engagement conditions for geographic positions engaged by the wheels 43. In some embodiments the apparatus at a later time, when returning to an already engaged land geographic position, the apparatus modifies the control of the controllable suspension system in response to the computer readable media stored geographic data map, in some embodiments using a stored map to know when to adjust and change the suspension system from past history saved in map data. In some embodiments the apparatus output signals the computer readable media stored geographic data map indicating land terrain suspension land engagement conditions for geographic positions engaged by the wheels 43 to an external computer. In some embodiments the apparatus receives a shared computer readable media stored geographic data map indicating land terrain suspension land engagement conditions for geographic positions engaged by the wheels 43 of another vehicle from an external computer.

In an embodiment, the data-logging truck control system 11 comprises a monitoring method for diagnosing faults in a plurality of data-logging trucks 37. The method comprises providing a plurality of data-logging trucks 37 comprised a body 39, a power plant 41 and a plurality of wheels 43, the wheels 43 for engaging land and propelling the data-logging trucks 37 across land, the data-logging trucks 37 including a controllable suspension system, the controllable suspension system for controlling a plurality of suspension movements between the body 39 and the wheels 43, the controllable suspension system including a plurality of suspension sensors 25 located proximal to all or some of the wheels 43 suspension locations 27 for sensing a plurality of suspension measurables and outputting a plurality of suspension sensor measurement output signals; the controllable suspension system including a plurality of controllable force suspension members 29 located proximal the wheels 43 and the suspension sensors 25, the controllable force suspension members 29 for applying a plurality of controllable suspension travel forces between the body 39 and the wheels 43 to control the suspension movements; the controllable suspension system including a body motion sensor 31, the body motion sensor 31 for outputting a plurality of vehicle body motion measurement output signals. The method comprises receiving the suspension sensor measurement output signals and the vehicle body motion measurement output signals and executing controllable suspension system instructions for controlling the controllable force suspension members 29 to control vehicle body motion and the suspension movements between the vehicle bodies and the wheels 43. The method comprises providing computer readable failure mode reference identification data for detecting a failure mode in the controllable suspension systems and comparing monitored controllable suspension system data to the failure mode reference identification data to a diagnose an impending failure mode of the controllable suspension systems. In some embodiments the method comprises providing the vehicles with a global geographic positioning input device for providing each vehicle with its geographic positioning input while engaging land (GPS, global position satellite, inertia guidance tracking positioning) and collecting the suspension sensor measurement output signals and the vehicle body motion measurement output signals with the geographic positioning inputs to provide a computer readable media stored geographic data map indicating land terrain suspension land engagement conditions for geographic positions engaged by the wheels 43. In some embodiments the method comprises outputting the computer readable media stored geographic data map indicating land terrain suspension land engagement conditions for geographic positions engaged by the wheels 43 to an external computer. In some embodiments the method comprises sharing the computer readable media stored geographic data map indicating land terrain suspension land engagement conditions for geographic positions engaged by the wheels 43 with a plurality of the vehicles. In some embodiments the method comprises adjusting the controllable suspension system in response to the computer readable media stored geographic data map indicating land terrain suspension land engagement conditions for geographic positions engaged by the wheels 43 when returning to the geographic position. In some embodiments the method comprises adjusting the controllable suspension system in response to the shared computer readable media stored geographic data map indicating land terrain suspension land engagement conditions for geographic positions engaged by the wheels 43 when engaging land at the collected geographic position. In some embodiments the method comprises outputting to an external computer at least one controllable suspension system data output chosen from the controllable suspension system data output group of the suspension sensor measurement output signals, the vehicle body motion measurement output signals, the compared monitored controllable suspension system data, the failure mode reference identification data, and the diagnose of an impending failure mode. In some embodiments the method comprises sharing the controllable suspension system data output with a plurality of the vehicles.

In an embodiment the data-logging truck control system 11 comprises a data-logging truck 37 for driving by an occupant human driver 100. The data-logging truck 37 comprises a body 39, a power plant 41 and a plurality of wheels 43, the wheels 43 for engaging land and propelling the data-logging truck across land. The data-logging truck 37 comprises a controllable suspension system 21 for controlling a plurality of suspension movements between the body 39 and the wheels 43. The data-logging truck 37 comprises a computer system 23 with computer readable medium 24. The data-logging truck 37 comprises a plurality of suspension sensors 25 located proximal to the wheels 43 for measuring a plurality of suspension parameters representative of suspension movements between the body 39 and the wheels 43 and outputting a plurality of suspension sensor measurement output signals. The data-logging truck 37 comprises a plurality of controllable force suspension members 29 located proximal the wheels 43 and the suspension sensors 25, the controllable force suspension members 29 for applying a plurality of controllable suspension travel forces between the body 39 and the wheels 43 to control the suspension movements. The data-logging truck 37 comprises a body motion sensor 31, the body motion sensor 31 for outputting a plurality of vehicle body motion measurement output signals. The data-logging truck 37 comprises a vehicle databus 33 interfacing with the computer system 23, the vehicle databus 33 communicating a plurality of vehicle data communication signals. In some embodiments the computer system 23 receives the suspension sensor measurement output signals and the vehicle body motion measurement output signals and the computer readable medium 24 comprises first program instructions with the computer system 23 executing a controllable suspension system control algorithm for controlling the controllable force suspension members 29 to control vehicle body motion and the suspension movements between the body 39 and the wheels 43, and the computer readable medium 24 comprises second program instructions with the computer system 23 executing a driver suspension feedback algorithm for monitoring signals, in some embodiments including vehicle data communication signals, to identify an impending driver vehicle safety margin and controlling the controllable force suspension members 29 to warn the driver 100 of the impending driver vehicle safety margin. In some embodiments the driver suspension feedback algorithm comprises a driver vehicle speed regulation override which controls the controllable force suspension members 29 to provide the warning to the driver 100 of the impending driver vehicle safety margin.

In some embodiments the controllable force suspension members 29 are controlled to warn the driver 100 of the impending driver vehicle safety margin. In some embodiments the controllable force suspension members 29 are controlled to warn the driver 100 of the impending driver vehicle safety margin by increasing a level of power absorbed by the driver 100 by increasing the transmission of force through the controllable force suspension members 29, in some embodiments as compared to maximizing isolation of the driver 100 from the terrain and decreasing the level of power absorbed by the driver 100. In some embodiments instead of controlling the suspension members 29 to limit driver 100 absorbed power, the system increases driver absorbed power as driver 100 increases speed, wherein the drivers speed is reduced/regulated as the drivers speed approaches the safety margin. In some embodiments the computer system executes a regime recognition algorithm for using the output signals and the vehicle data communication signals from the databus to determine a vehicle operating parameter of the vehicle 37 and how the driver 100 is driving the vehicle 37.

In some embodiments the driver suspension feedback algorithm monitors the vehicle data communication signals, the suspension sensor measurement output signals, and the vehicle body motion measurement output signals to identify the impending driver vehicle safety margin and control the controllable force suspension members 29 to warn the driver 100 of the impending driver vehicle safety margin. In some embodiments the computer system executes a regime recognition algorithm for using the signals including the vehicle data communication signals from the databus to determine a vehicle operating configuration of the vehicle 37.

In some embodiments controlling the controllable force suspension members 29 to warn the driver 100 of the impending driver vehicle safety margin comprises increasing a suspension control gain of at least one controllable force suspension member 29. In some embodiments the system increases the suspension control gain by increasing a suspension control damping gain to at least one controllable force suspension member damper to warn the driver. In some embodiments the system increases driver absorbed power while enhancing vehicle stability by increasing suspension inertial damping gains. In some embodiments the controllable suspension system algorithm is modified in response to the regime recognition algorithm. In some embodiments controlling the controllable force suspension members 29 to warn the driver 100 of the impending driver vehicle safety margin comprises increasing a suspension damping force gain. In some embodiments the system executes a regime recognition algorithm for using the output signals and the vehicle data communication signals from the databus to determine at least a vehicle operating parameter and a vehicle operating configuration and wherein the controllable suspension system algorithm is modified in response to the regime recognition algorithm, in some embodiments with an increased suspension control gain warning the driver.

In some embodiments controlling the controllable force suspension members 29 to warn the driver 100 of the impending driver vehicle safety margin comprises repetitively switching between a suspension high damping state and a suspension low damping state. In some embodiments an overspeed indicator warning is provided to the driver by dithering the vehicle suspension between two different suspension states, in some embodiments switching a semi-active damper quickly between high and low damping state such that driver 100 physically feels the effects of such personally. In some embodiments the at least first controllable force suspension member 29 is comprised of a semi-active damper.

In some embodiments the driver suspension feedback algorithm monitors a measured calculated vehicle gross weight and a driver driving pattern to identify an unsafe driving speed impending driver vehicle safety margin and controls the controllable force suspension members 29 to warn the driver 100 of the impending driver vehicle safety margin. In some embodiments at least a first controllable force suspension member 29 is comprised of an actuator.

In some embodiments the driver suspension feedback algorithm monitors for an impending vehicle roll-over regime and control the controllable force suspension members 29 to warn the driver 100 of the impending vehicle roll-over regime. In some embodiments the driver suspension feedback algorithm monitors at least one roll-over signal selected from the roll-over signal input group including vehicle lateral acceleration input signals, roll-rate input signals, and steering wheel angle input signals.

In some embodiments the driver suspension feedback algorithm monitors the measured vehicle gross weight and a vehicle speed and controls the controllable force suspension members 29 to warn the driver 100 of an impending driver vehicle safety margin speed for the measured vehicle gross weight, in some embodiments with the speed regulation override algorithm responding to measured vehicle gross weight and vehicle speed and controls the suspension to regulate the vehicle speed.

In some embodiments the body motion sensor vehicle body motion measurement output signals comprise a plurality of accelerometer output signals.

In some embodiments the body motion sensor vehicle body motion measurement output signals comprise a plurality of six degrees of freedom of body motion output signals.

In some embodiments the computer system stores a plurality of condition data for a plurality of vehicle components in the computer readable medium.

In an embodiment a method of controlling a data-logging truck 37 driven by an occupant driver 100. The vehicle comprises a body 39 and a power plant 41. In some embodiments the vehicle 37 comprises a plurality of wheels 43, the wheels 43 for engaging land and propelling the data-logging truck 37 across land. The vehicle 37 comprises a controllable suspension system 21, the controllable suspension system 21 for controlling a plurality of suspension movements, in some embodiments between the body 39 and the wheels 43. The method comprises providing a plurality of suspension sensors 25 for measuring a plurality of suspension parameters representative of suspension movements of the body 39 and outputting a plurality of suspension sensor measurement output signals. The method comprises providing a plurality of controllable force suspension members 29, the controllable force suspension members 29 for applying a plurality of controllable suspension travel forces to control the suspension movements. The method comprises providing a body motion sensor 31, the body motion sensor 31 for outputting a plurality of vehicle body motion measurement output signals. The method comprises monitoring signals, to identify an impending driver vehicle safety margin and controlling the controllable force suspension members 29 to inhibit the driver from crossing into the identified impending driver vehicle safety margin. In some embodiments the computer system 23 receives the suspension sensor measurement output signals and the vehicle body motion measurement output signals and the computer readable medium 24 including a first program instruction with the computer system executing a controllable suspension system algorithm for controlling the controllable force suspension members 29 to control vehicle body motion and the suspension movements between the body 39 and the wheels 43, and the computer readable medium including a second program instruction with the computer system 23 executing a driver suspension feedback algorithm for monitoring vehicle data communication signals to identify an impending driver vehicle safety margin and controlling the controllable force suspension members to warn the driver of the impending driver vehicle safety margin.

In some embodiments controlling the controllable force suspension members 29 to warn the driver 100 of the impending driver vehicle safety margin comprises increasing a level of power absorbed by the driver 100, in some embodiments with the system instead of controlling the suspension members 29 to limit driver absorbed power, the system increases driver 100 absorbed power as driver 100 increases speed to inhibit crossing the approaching safety margin, in some embodiments with such suspension feedback the driver reduces/regulates the speed when approaching the safety margin.

In some embodiments the computer system comprises instructions with the computer system executing a regime recognition algorithm for using the sensor output signals and the vehicle data communication signals from the databus to determine vehicle operating parameters and vehicle operating configurations.

In some embodiments the system monitors the vehicle data communication signals, the suspension sensor measurement output signals, and the vehicle body motion measurement output signals to identify the impending driver vehicle safety margin and controls the controllable force suspension members to warn the driver of the impending driver vehicle safety margin.

In some embodiments controlling the controllable force suspension members to warn the driver of the impending driver vehicle safety margin comprises increasing a suspension control gain, in some embodiments with increasing driver absorbed power while enhancing vehicle stability by increasing the suspension control damping gains in suspension members 29. In some embodiments control of suspension members 29 is modified in response to a regime recognition algorithm, in some embodiments with increased suspension control gains warning the driver. In some embodiments controlling the controllable force suspension members 29 to warn the driver 100 of the impending driver vehicle safety margin comprises increasing a suspension damping gain for controllable force suspension member damper. In some embodiments the system executes a regime recognition algorithm for using the sensor output signals and the vehicle data communication signals from the databus to determine at least a vehicle operating parameter and a vehicle operating configuration and wherein the controllable suspension system algorithm is modified in response to the regime recognition algorithm.

In some embodiments controlling the controllable force suspension members 29 to warn the driver 100 of the impending driver vehicle safety margin comprises repetitively switching between a suspension high damping state and a suspension low damping state. In some embodiments the driver is warned of an overspeed safety margin by dithering the vehicle suspension between two different suspension states, in some embodiments switching a semi-active damper quickly between high and low damping states such that driver 100 feels the effects of such physically and personally.

In some embodiments the method comprises monitoring a measured vehicle gross weight and a driver driving pattern to identify an unsafe driving speed impending driver vehicle safety margin and controlling the controllable force suspension members 29 to warn the driver of the impending driver vehicle safety margin.

In some embodiments the method comprises monitoring for an impending vehicle roll-over regime and controlling the controllable force suspension members 29 to warn the driver of the impending vehicle roll-over regime.

In some embodiments the method comprises monitoring at least one roll-over input signal selected from the roll-over signal group including vehicle lateral acceleration signals, roll-rate signals, and steering wheel angle signals.

In some embodiments the method comprises monitoring the measured vehicle gross weight and a vehicle speed and controlling the controllable force suspension members to warn the driver of an impending driver vehicle safety margin speed for the measured vehicle gross weight. In some embodiments a speed regulation algorithm responds to measured vehicle gross weight and vehicle speed and controls the suspension to regulate the vehicle speed.

In an embodiment the data-logging truck control system 11 comprises a vehicle driver control system for controlling a vehicle 37 driven by an occupant driver 100, the vehicle 37 comprising a body 39, a power plant 41, and a controllable suspension sub-system 21, the controllable suspension sub-system 21 for controlling a plurality of suspension movements. The vehicle driver control system comprises a plurality of suspension sensors 25 for measuring a plurality of suspension parameters representative of suspension movements of the body 39 and outputting a plurality of suspension sensor measurement output signals. The vehicle driver control system comprises a plurality of controllable force suspension members 29, the controllable force suspension members 29 for applying a plurality of controllable suspension travel forces. The vehicle driver control system comprises a body motion sensor 31, the body motion sensor 31 for outputting a plurality of vehicle body motion measurement output signals. The vehicle driver control system comprises a vehicle databus 33, the vehicle databus 33 communicating a plurality of vehicle data communication signals. The vehicle driver control system comprises a computer sub-system 23 for monitoring vehicle data communication signals to identify an impending driver vehicle safety margin and controlling the controllable force suspension members 29 to inhibit the driver 100 from crossing into the impending driver vehicle safety margin. In some embodiments the computer sub-system 23 receives the suspension sensor measurement output signals and the vehicle body motion measurement output signals and the computer readable medium 24 comprises a first program instruction with the computer sub-system 23 executing a controllable suspension sub-system algorithm for controlling the controllable force suspension members 29 to control vehicle body motion and the suspension movements between the body 39 and the wheels 43, and the computer readable medium 24 including a second program instruction with the computer sub-system 23 executing a driver suspension feedback algorithm for monitoring vehicle data communication signals to identify an impending driver vehicle safety margin and controlling the controllable force suspension members 29 to warn the driver of the impending driver vehicle safety margin.

In some embodiments computer sub-system 23 controls the controllable force suspension members 29 to warn the driver 100 of the impending driver vehicle safety margin with an increasing level of power absorbed by the driver 100. In some embodiments computer sub-system 23 instead of controlling the suspension members 29 to limit driver absorbed power, the computer sub-system 23 increases driver absorbed power as the driver 100 increases speed, wherein the driver 100 is regulated to reduce the speed when approaching the safety margin. In some embodiments the computer sub-system computer readable medium 24 comprises program instructions with the computer sub-system 23 executing a regime recognition algorithm for using the sensor output signals and the vehicle data communication signals from the databus to determine a vehicle operating parameter.

In some embodiments computer sub-system 23 monitors the vehicle data communication signals, the suspension sensor measurement output signals, and the vehicle body motion measurement sensor output signals to identify the impending driver vehicle safety margin and controls the controllable force suspension members 29 to warn the driver of the impending driver vehicle safety margin. In some embodiments the computer sub-system 23 computer readable medium 24 comprises a program instruction with the computer sub-system executing a regime recognition algorithm for using the output signals and the vehicle data communication signals from the databus to determine a vehicle operating configuration.

In some embodiments the computer sub-system 23 controls the controllable force suspension members 29 to warn the driver 100 of the impending driver vehicle safety margin by increasing a suspension control gain, in some embodiments while increasing driver absorbed power and enhancing vehicle stability by increasing suspension damping gains. In some embodiments the control of the controllable force suspension members 29 is modified in response to the regime recognition algorithm.

In some embodiments the computer sub-system 23 comprises a regime recognition algorithm for using the output signals and the vehicle data communication signals from the databus to determine at least a vehicle operating parameter and a vehicle operating configuration and wherein the controllable suspension algorithm is modified in response to the regime recognition algorithm.

In some embodiments the computer sub-system 23 controls the controllable force suspension members 29 to warn the driver 100 of the impending driver vehicle safety margin by repetitively switching between a suspension high damping state and a suspension low damping state. In some embodiments an overspeed warning is provided by dithering the vehicle suspension between two different suspension states, in some embodiments switching a semi-active damper member 29 quickly between high and low damping states such that driver 100 feels the effects of such physically and personally. In some embodiments the controllable force suspension members 29 comprises an actuator.

In some embodiments the computer sub-system 23 monitors a measured vehicle gross weight and a driver driving pattern to identify an unsafe driving speed impending driver vehicle safety margin and controls the controllable force suspension members 29 to warn the driver 100 of the impending driver vehicle safety margin.

In some embodiments the computer sub-system 23 monitors for an impending vehicle roll-over regime and controls the controllable force suspension members 29 to warn the driver 100 of the impending vehicle roll-over regime.

In some embodiments the computer sub-system 23 monitors at least one roll-over signal input selected from the roll-over signal input group including vehicle lateral acceleration signals, roll-rate signals, and steering wheel angle signals.

In some embodiments the computer sub-system 23 monitors the measured vehicle gross weight and a vehicle speed and controls the controllable force suspension members 29 to warn the driver 100 of an impending driver vehicle safety margin speed for the measured vehicle gross weight, in some embodiments with a speed regulation algorithm responding to measured vehicle gross weight and vehicle speed and controlling the suspension to regulate the vehicle speed.

In an embodiment the data-logging truck control system 11 comprises a system for controlling a vehicle 37 driven by a human occupant driver 100, the vehicle 37 comprising a body 39, a power plant 41, and a controllable suspension 21, the controllable suspension 21 for controlling a plurality of suspension movements. The system comprises a means for outputting a plurality of suspension measurement signals. The system comprises at least a first controllable force suspension member 29, the controllable force suspension member 29 for applying a plurality of controllable suspension travel forces. The system comprises a means for outputting a plurality of body motion measurement signals. The system comprises a means for communicating a plurality of vehicle data communication signals. The system comprises a control means for monitoring the signals to identify an impending driver vehicle safety margin and controlling the controllable force suspension member 29 to warn the driver 100 of the impending driver vehicle safety margin.

In some embodiments the control means increases a transmission level of environmental inputs through the controllable force suspension member 29 to notify the driver 100 of the impending driver vehicle safety margin. In some embodiments the suspension system 21 transmits increased road terrain inputs to driver 100 proximate the impending driver vehicle safety margin, such as for the same road terrain but at a first safe speed and/or gross vehicle weight transmission through suspension system 21 is minimized while maintaining vehicle performance and stability, and for the vehicle and same road terrain but at a second unsafe speed and/or gross vehicle weight transmission through suspension system 21 to the driver 100 is not minimized but increased to warn of the driver 100 of the vehicle safety margin. In some embodiments the computer sub-system 23 receives the suspension sensor measurement output signals and the vehicle body motion measurement output signals and the computer readable medium 24 comprises a first program instructions with the computer sub-system executing a controllable suspension sub-system algorithm for controlling the controllable force suspension members 29 to control vehicle body motion and the suspension movements between the body 39 and the wheels 43, and the computer readable medium 24 comprises second program instructions with the computer sub-system executing a driver suspension feedback algorithm for monitoring vehicle data communication signals to identify an impending driver vehicle safety margin and controlling the controllable force suspension members 29 to warn the driver of the impending driver vehicle safety margin.

The data-logging truck control systems 11 disclosed herein provide for an improved isolation of payloads of off-road vehicles using magnetorheological (MR) fluid dampers, and in particular isolating payloads for oil field data-logging trucks. Using MR damper technology, the payloads are isolated to react to dampen the amplitude of the vibrations experienced by the payload as tied to the vehicle speed. The payload is carried by an adaptive suspension to protect it from jarring terrain and the MR damper technology helps off-road vehicles resist rollover. In some embodiments, MR dampers are installed on or about or generally associated with each wheel location to support the vehicle body on the chassis of the truck. Each MR damper may be associated with a position and velocity sensor that may be located therewith. Some MR dampers may be connected via a harness or wirelessly to a controller and a set of inertial sensors receive input from one or more of the MR dampers and their associated sensors. The controller and inertial sensors may monitor the movement of the vehicle, calculate optimal damping based upon speed and motion, and provide input to each of the damper to exert the appropriate level of damping based upon the detected conditions. The input may be in the form of a power input. The controller may employ a plurality of algorithms to control various motions of a data-logging truck and/or a payload of a data-logging truck. An algorithm may control roll, pitch and/or heave of a data-logging truck and/or a payload of a data-logging truck. Another algorithm may minimize and/or reduce peak acceleration and loads transmitted to the driver and/or the payload of the data-logging truck. Still another algorithm may control wheel resonant modes. Yet another algorithm may control roll, over/under steer, and braking dive of the data-logging truck.

Referring now to FIG. 14, a flowchart of a method 200 of controlling a data-logging truck is shown. Method 200 may begin at block 202 by providing information regarding payload 51 physical properties and location to a data-logging truck control system 11. In some embodiments, the information may comprise size, weight, relative location to one or more components of the data-logging truck control system 11 and/or relative location to at least one of a first inertial reference zone 55 and a second inertial reference zone 57. In some embodiments, the second inertial reference zone 57 may be associated with a location of a driver 200. The method 200 may continue at block 204 by providing a relative importance value for association with the payload 51. The method 200 may continue at block 206 by operating the data-logging truck control system 11 to selectively protect the payload 51 as a function of the relative importance value. For example, the relative importance value may be increased to increasingly protect the payload 51 from vibration and/or impulse shock forces and may be decreased to decreasingly protect the payload 51 from vibration and/or impulse shock forces. In some cases, increasing the relative importance value may decrease an amount of protection and/or isolation a driver 100 is provided by the data-logging truck control system 11 so that the driver 100 absorbs more power or energy.

Referring now to FIG. 15, a flowchart of a method 300 of controlling a data-logging truck is shown. Method 300 may begin at block 302 by providing a relative importance value for association for a payload 51. The method 300 may continue at block 304 by operating the data-logging truck control system 11 to control an amount of power absorbed by a driver 100 as a function of the relative importance value.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to comprise iterative ranges or limitations of like magnitude falling within the expressly stated ranges or limitations (e.g., from about 1 to about 10 comprises, 2, 3, 4, etc.; greater than 0.10 comprises 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A data-logging truck, the data-logging truck comprising:
a truck including a power plant and a cab;
at least four wheels associated with the truck for propelling and guiding the truck, wherein the wheels are mechanically connected to the power plant;
an electrical power source associated with the truck;
a data acquisition housing secured to the truck;
a magneto-rheological damper associated with each wheel, wherein the magneto-rheological damper has a first end and a second end, the first end connected to the wheel;
at least two connection points associated with the cab and at least two connection points associated with the data acquisition housing, the connection points providing connectivity for the second end the associated magneto-rheological damper;
at least one inertial sensor; and
at least one controller having at least one control algorithm, the controller in electrical communication with the electrical power source, wherein the controller determines a distribution of electrical power to each magneto-rheological damper based upon an input from the inertial sensor and the algorithm.

2. The data-logging truck of claim 1, wherein the controller further comprises an algorithm providing control of roll, pitch and heave.

3. The data-logging truck of claim 1, wherein the controller further comprises an algorithm minimizing peak acceleration and loads.

4. The data-logging truck of claim 1, wherein the controller further comprises an algorithm providing control of wheel resonant modes.

5. The data-logging truck of claim 1, wherein the controller further comprises an algorithm providing control of roll, over/under steer, and braking dive.

6. The data-logging truck of claim 1, wherein the inertial sensor continually measures longitudinal, lateral and vertical motion of the data logging truck.

7. The data-logging truck of claim 6, wherein the controller provides an electrical power input to the magneto-rheological dampers to resist rollover of the data logging truck in response to a lateral motion input from the inertial sensor.

8. The data-logging truck of claim 1, further comprising a position and a velocity sensor located at each wheel, wherein the position and velocity sensors are in electronic communication with the controller.

9. The data-logging truck of claim 1, further comprising a wired harness providing communications between the magneto-rheological dampers, the position and velocity sensors, the controller, and the inertial sensors.

10. The data-logging truck of claim 1, further comprising wireless communications between the magneto-rheological dampers, the position and velocity sensors, the controller, and the inertial sensors.

11. The data-logging truck of claim 1, wherein the magneto-rheological damper further comprises:
a damper body having a reservoir for a magneto-rheological fluid;
a piston rod;
a piston rod guide disposed within the damper body, the piston rod guide having a passage therein for receiving the piston rod;
at least a first piston rod seal and at least a second piston rod seal arranged to seal between the piston rod guide and the piston rod;
a fluid chamber defined between the piston rod guide and the piston rod, the fluid chamber being in communication with the reservoir;
a piston rod guide filter arranged in a communication path between the fluid chamber and the reservoir to filter particulates out of the magneto-rheological fluid entering the fluid chamber, wherein the piston rod guide filter includes a magnetic field generator; and
an accumulator arranged between the piston rod guide and the damper body.

12. The data-logging truck of claim 11, further comprising a piston rod bearing assembly coupled to the piston rod guide and arranged to engage and support reciprocal motion of the piston rod.

13. The data-logging truck of claim 11, wherein the accumulator comprises a diaphragm.

14. The data-logging truck of claim 11, wherein the accumulator comprises a gas charged piston.

15. The data-logging truck of claim 11, wherein the magnetic field generator is a permanent magnet.

16. The logging truck of claim 11, wherein the magnetic field generator is an electromagnetic coil.

17. The logging truck of claim 11, wherein the piston rod guide filter includes a fluid conduit in communication with the reservoir.

18. The logging truck of claim 17, wherein the filtering media is disposed in the fluid conduit.

19. The logging truck of claim 11, wherein the fluid chamber is defined between the at least first and second piston rod seals.

20. A data-logging truck comprising:
a body;
a power plant;
a plurality of wheels, said wheels for engaging land and propelling said data-logging truck across land, said data-logging truck including a controllable suspension system, said controllable suspension system for controlling a plurality of suspension movements between said body and said wheels,
a computer system;
a plurality of suspension sensors located proximal to said wheels for measuring a plurality of suspension parameters representative of suspension movements between said body and said wheels, said sensor providing a plurality of suspension sensor measurement output signals;
a plurality of controllable force suspension members located proximal said wheels and said suspension sensors, said controllable force suspension members for applying a plurality of controllable suspension travel forces between said body and said wheels to control said suspension movements;
a body motion sensor, said body motion sensor for outputting a plurality of vehicle body motion measurement output signals;
a vehicle databus interfacing with said computer system, said vehicle databus communicating a plurality of vehicle data communication signals;
wherein said computer system receives said suspension sensor measurement output signals and said vehicle body motion measurement output signals and said computer readable medium including a first program instruction with said computer system executing a controllable suspension system algorithm for controlling said controllable force suspension members to control vehicle body motion and said suspension movements between said body and said wheels.

21. The data-logging truck as claimed in claim 20 wherein said body motion sensor vehicle body motion measurement output signals comprise a plurality of accelerometer output signals.

22. The data-logging truck as claimed in claim 20 wherein said body motion sensor vehicle body motion measurement output signals comprise a plurality of six degrees of freedom of body motion output signals.

23. The data-logging truck as claimed in claim 20 wherein said computer system stores a plurality of condition data for a plurality of vehicle components in said medium.

24. A method of minimizing an input force transmitted to a data-logging truck, said method comprising the steps:
providing a data-logging truck, said data-logging truck having a body, a power plant, and a controllable suspension system, said controllable suspension system for controlling a plurality of suspension movements;
providing a plurality of suspension sensors for measuring a plurality of suspension parameters representative of suspension movements of said body and outputting a plurality of suspension sensor measurement output signals;
providing a plurality of controllable force suspension members, said controllable force suspension members for applying a plurality of controllable suspension travel forces;
providing a body motion sensor, said body motion sensor for outputting a plurality of vehicle body motion measurement output signals;
monitoring a plurality of sensor signals to identify an impending driver vehicle safety margin; and
controlling said controllable force suspension members to minimize the input force transmitted to the data-logging truck.

25. The method as claimed in claim 24, wherein the step of controlling said controllable force suspension members further comprises the step increasing a level of power absorbed by said controllable suspension system.

26. The method as claimed in claim 24, further comprising monitoring a plurality of vehicle data communication signals from a vehicle databus, a plurality of suspension sensor measurement output signals, and a plurality of body motion measurement output signals to identify said input force transmitted to the data-logging truck and controlling said controllable force suspension members to inhibit the magnitude of the input force transmitted to the data-logging truck.

27. The method as claimed in claim 24, wherein controlling said controllable force suspension members to inhibit said driver of said impending driver vehicle safety margin comprises controlling said controllable force suspension members to warn said driver of said impending driver vehicle safety margin.

28. The method as claimed in claim 27, further comprising the step of increasing a suspension control gain to control said controllable force suspension members.

29. The method as claimed in claim 27 further comprising repetitively switching between a suspension high damping state and a suspension low damping state to control said controllable force suspension members.

30. The method as claimed in claim 24 further comprising monitoring said measured vehicle gross weight and a vehicle speed and controlling said controllable force suspension members to inhibit the magnitude of the input force transmitted to the data-logging truck.
